(19) United States
(12) Patent Application Publication
(10) Pub. No.: US 2014/0195481 A1
(43) Pub. Date: Jul. 10, 2014

(54) CONTENT MANAGING APPARATUS AND CONTENT MANAGING METHOD

(71) Applicant: Panasonic Corporation, Osaka (JP)

(72) Inventors: Satoru Takagishi, Osaka (JP); Yasuhiro Yuki, Kanagawa (JP)

(73) Assignee: Panasonic Corporation, Osaka (JP)

(21) Appl. No.: 14/238,336

(22) PCT Filed: Jun. 7, 2013
(86) PCT No.: PCT/JP2013/003601

§ 371 Date: Feb. 11, 2014

(30) Foreign Application Priority Data
Jun. 14, 2012 (JP) 2012-135133

(51) Int. Cl. G06F 17/30

(52) U.S. Cl. CPC G06F 17/3007
USPC 707/610; 707/609; 707/679

(57) ABSTRACT

A content managing apparatus according to this disclosure includes: a content information editing unit newly adding first content information to a content managing unit; operation history information editing unit adding first operation history information to an operation history managing unit when second content information identifying a second content item used in the editing operation of the first content item is stored in a DB unit; and an associating unit storing information indicating a parent-child relationship of the first content item and the second content item and information for associating the first operation history information with the first content information and the second content information, into an association management region included in each of the first content information and the second content information in the content managing unit when the first operation history information is added by the operation history information editing unit.

### TECHNICAL FIELD

The present invention relates to content managing apparatuses and content managing methods, and in particular to a content managing apparatus and a content managing method for managing a content item.

### BACKGROUND ART

With the advancement in digital technologies and electronic terminals, data such as image data and video data can be viewed not only using personal computers (PCs) but also using various electronic terminals such as home electric appliances, tablet terminals, and mobile phones with multiple functions.

In addition, a data usage method for editing such data using the respective electronic terminals, and sharing the edited data with other people via a network is available. Especially with the widespread use of social network services (hereinafter referred to as SNS) which are services for establishing friendships on the Internet to enable communication, users can not only edit data (image data or video data) shared by other users but also easily share the edited data on SNS.

Digital data such as image data and video data is easily replicated without deterioration. In addition, it is also easy to generate new data by performing editing operation, such as combining data items or trimming data (editing operation for cutting out part of image data or the like). Ease of the replication or editing of data contributes to generation of a large number of content items. However, when performing editing operation such as replication via a network, too many content items to be managed by a single electronic terminal or a single person are generated in some cases.

In addition, as a method of managing a large number of content items, a method of managing content items in a database (hereinafter referred to as a DB) provided in an electronic terminal is generally known. However, with the DB provided in an electronic terminal, there is a problem that it is difficult to manage content items which have been transferred outside the device via a network, and that the management function is not allowed to work when the network has been disconnected.

In view of the above, for example, Patent Literature (PTL) 1 proposes a method of registering and managing content information or property information of an author or a person of portrait using a content managing server connected to a network,

### CITATION LIST

### Patent Literature

### [PTL 1] Japanese Unexamined Patent Application Publication No. 2006-146426

### SUMMARY OF INVENTION

### Technical Problem

However, with the above-described conventional technique, when a new content item is generated by editing, such as combining a plurality of content items or trimming part of a content item, information of an author, a person of portrait, and so on continues to increase, which is likely to pose a problem that the information is migrated as being inaccurate, for example.

The present invention has been conceived in view of the circumstances described above, and an object of the present invention is to provide a content managing apparatus and the like which are capable of properly managing a relationship between a large number of content items.

### Solution to Problem

In order to achieve the above-described object, a content managing apparatus according to an aspect of the present invention is a content managing apparatus for managing a content item using a storage unit including a content information management region and an operation history management region, the content managing apparatus including: a content information editing unit configured to newly add first content information for identifying a first content item to the content information management region; an operation history information editing unit configured to add, to the operation history management region, first operation history information indicating history of an editing operation performed on the first content item, when second content information for identifying a second content item used in the editing operation performed on the first content item is stored in the storage unit; and an associating unit configured to store (i) information indicating a parent-child relationship between the first content item and the second content item and (ii) information for associating the first operation history information with the first content information and the second content information, into an association management region included in each of the first content information and the second content information in the content information management region, when the first operation history information is added by the operation history information editing unit.

It is to be noted that these general and specific aspects may be implemented using a system, a method, an integrated circuit, a computer program, or a recording medium, or any combination of systems, methods, integrated circuits, computer programs, or recording media.

### Advantageous Effects of Invention

According to the present invention, it is possible to implement a content managing apparatus capable of properly managing a relationship between a large number of content items.

### BRIEF DESCRIPTION OF DRAWINGS

FIG. 1 is a configuration diagram of a conventional decentral content management system.

FIG. 2 is a diagram illustrating an example of data managed by the conventional decentral content management system.

FIG. 3 is a configuration diagram of a content management system according to Embodiment 1.

FIG. 4 is a diagram illustrating an example of a hardware configuration of a content managing server and a terminal apparatus according to Embodiment 1.

FIG. 5A is a block diagram illustrating an example of a configuration of the content managing server according to Embodiment 1.

FIG. 5B is a block diagram illustrating an example of a detailed configuration of a DB generating unit according to Embodiment 1.

FIG. 6 is a block diagram illustrating an example of a configuration of the terminal apparatus according to Embodiment 1.

FIG. 7 is a diagram for explaining an outline of processing when data management is performed using the content management system according to Embodiment 1.

FIG. 8A is a diagram for explaining an operation of Example 1 according to Embodiment 1.

FIG. 8B is a diagram for explaining an operation of Example 1 according to Embodiment 1.

FIG. 8C is a diagram for explaining an operation of Example 1 according to Embodiment 1.

FIG. 8D is a diagram for explaining an operation of Example 1 according to Embodiment 1.

FIG. 9 is a diagram illustrating the operation sequence of Example 1 according to Embodiment 1.

FIG. 10A is a diagram for explaining an operation of Example 2 according to Embodiment 1.

FIG. 10B is a diagram for explaining an operation of Example 2 according to Embodiment 1.

FIG. 10C is a diagram for explaining an operation of Example 2 according to Embodiment 1.

FIG. 10D is a diagram for explaining an operation of Example 2 according to Embodiment 1.

FIG. 11 is a diagram illustrating the operation sequence of Example 2 according to Embodiment 1.

FIG. 12A is a diagram for explaining an operation of Example 3 according to Embodiment 1.

FIG. 12B is a diagram for explaining an operation of Example 3 according to Embodiment 1.

FIG. 12C is a diagram for explaining an operation of Example 3 according to Embodiment 1.

FIG. 12D is a diagram for explaining an operation of Example 3 according to Embodiment 1.

FIG. 13 is a diagram illustrating the operation sequence of Example 3 according to Embodiment 1.

FIG. 14A is a diagram for explaining an operation of Example 4 according to Embodiment 1.

FIG. 14B is a diagram for explaining an operation of Example 4 according to Embodiment 1.

FIG. 14C is a diagram for explaining an operation of Example 4 according to Embodiment 1.

FIG. 14D is a diagram for explaining an operation of Example 4 according to Embodiment 1.

FIG. 15 is a diagram illustrating the operation sequence of Example 4 according to Embodiment 1.

FIG. 16A is a diagram for explaining an operation of Example 5 according to Embodiment 1.

FIG. 16B is a diagram for explaining an operation of Example 5 according to Embodiment 1.

FIG. 16C is a diagram for explaining an operation of Example 5 according to Embodiment 1.

FIG. 16D is a diagram for explaining an operation of Example 5 according to Embodiment 1.

FIG. 17 is a diagram illustrating the operation sequence of Example 5 according to Embodiment 1.

FIG. 18A is a diagram illustrating a description example of operation history according to Embodiment 1.

FIG. 18B is a diagram illustrating a description example of operation history according to Embodiment 1.

FIG. 19A is a block diagram illustrating an example of a configuration of the content managing server according to Embodiment 2.

FIG. 19B is a block diagram illustrating an example of a detailed configuration of a content restoration executing unit according to Embodiment 2.

FIG. 20 is a block diagram illustrating an example of a configuration of the terminal apparatus according to Embodiment 2.

FIG. 21 is a diagram for explaining an operation according to Embodiment 2.

FIG. 22A is a diagram for explaining an operation according to Embodiment 2.

FIG. 22B is a diagram for explaining an operation according to Embodiment 2.

FIG. 22C is a diagram for explaining an operation according to Embodiment 2.

FIG. 22D is a diagram for explaining an operation according to Embodiment 2.

FIG. 22E is a diagram for explaining an operation according to Embodiment 2.

FIG. 23A is a diagram illustrating the operation sequence according to Embodiment 2.

FIG. 23B is a diagram illustrating the operation sequence according to Embodiment 2.

FIG. 24A is a diagram for explaining an operation when generating a reduced image according to Embodiment 3.

FIG. 24B is a diagram for explaining an operation when generating a reduced image according to Embodiment 3.

FIG. 24C is a diagram for explaining an operation when generating a reduced image according to Embodiment 3.

FIG. 25 is a diagram illustrating the operation sequence for generating a reduced image according to Embodiment 3.

FIG. 26 is a block diagram illustrating an example of a configuration of a content managing server according to Embodiment 4.

FIG. 27 is a block diagram illustrating an example of a configuration of a terminal apparatus according to Embodiment 4.

FIG. 28A is a diagram for explaining an operation according to Embodiment 4.

FIG. 28B is a diagram for explaining an operation according to Embodiment 4.

FIG. 29 is a diagram illustrating the operation sequence according to Embodiment 4.

### DESCRIPTION OF EMBODIMENTS

### Underlying Knowledge Forming Basis of the Present Invention

The inventors have found the following problems related to the technique disclosed by PLT 1 described in the “Background” section.

As a method of managing a large number of content items, a method of managing content items in a DB provided in an electronic terminal is generally known. However, with the DB provided in an electronic terminal, there is a problem that it is difficult to manage content items which have been transferred outside the device via a network, and that the management function is not allowed to work when the network has been disconnected.

In view of the above, PTL 1 discloses a method with which, using a content managing server connected to a network, content information or property information of an author or a person of portrait is registered and managed, a content item is registered as a different content item when performing replication or editing operations, and author information and so on which have not changed from an original content item are migrated.

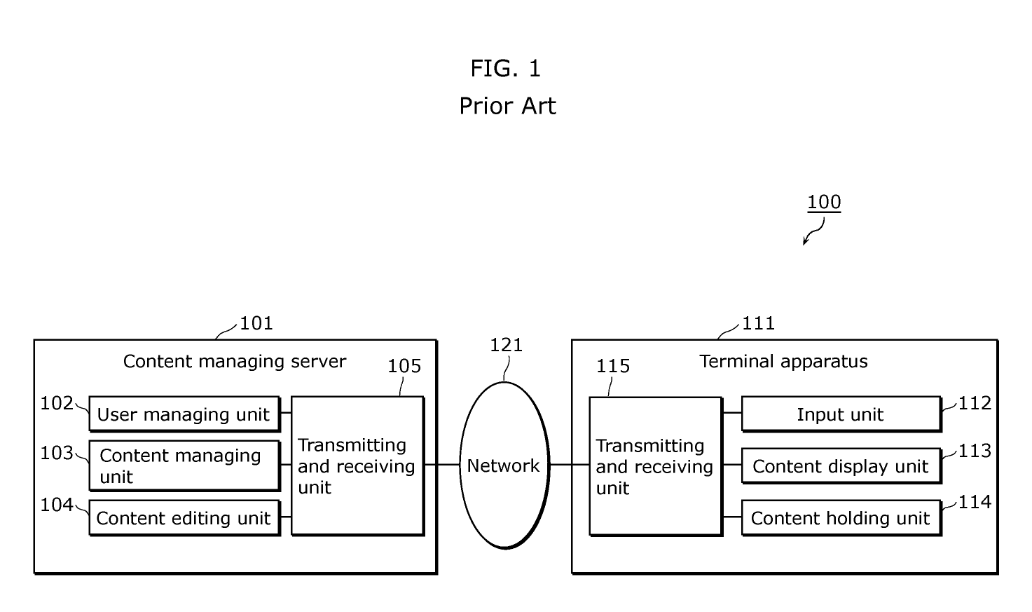

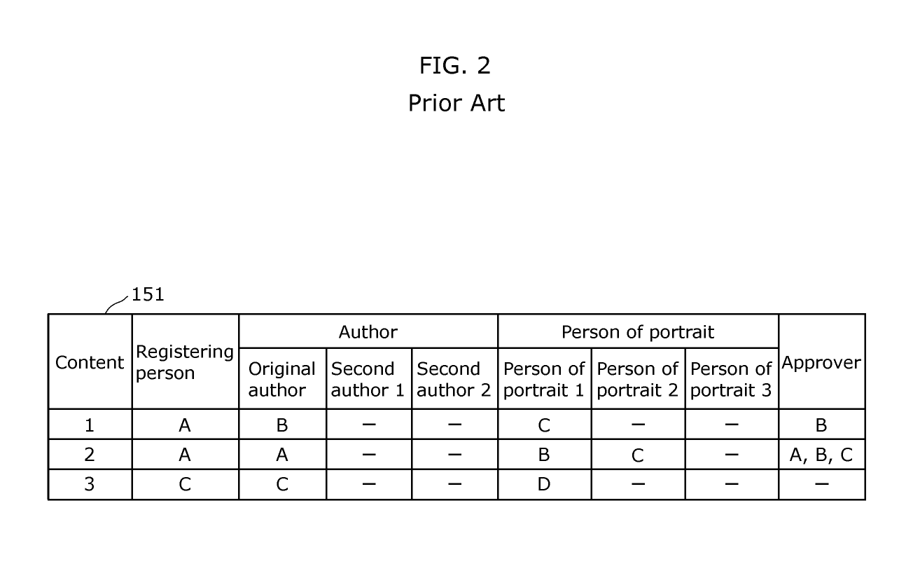

The following describes a decentral content managing method with use of a content managing server connected to a network, which is disclosed by PTL 1, with reference to FIG. 1 and FIG. 2.

FIG. 1 is a configuration diagram of a conventional decentral content management system. FIG. 2 is a diagram illustrating an example of a database managed by the conventional decentral content management system.

A decentral content management system 100 illustrated in FIG. 1 includes a content managing server 101 and a terminal apparatus 111 which are connected to a network 121.

The content managing server 101 includes: a user managing unit 102; a content managing unit 103; a content editing unit 104; and a transmitting and receiving unit 105. The terminal apparatus 111 includes: an input unit 112; a content display unit 113; a content holding unit 114; and a transmitting and receiving unit 115.

The content managing server 101 registers a content item held in the content holding unit 114 of the terminal apparatus 111 connected via the network 121, on the user managing unit 102 and the content managing unit 103, and manages the content item.

When editing a content item using the terminal apparatus 111, a user edits the content item using the content editing unit 104 of the content managing server 101. The content managing unit 103 of the content managing server 101 manages, as a different content item, the content item edited by the user using the terminal apparatus 111, as illustrated in FIG. 2. More specifically, the content managing unit 103 manages a DB 151 in which a registering person, an author, an approver, and the like are associated with a corresponding one of the edited content items, as illustrated in FIG. 2. For example, the content managing unit 103, when a content item is replicated or edited, migrates information of the author or the like, and newly adds information of the registering person, a second author, or the like to the DB 151 illustrated in FIG. 2.

However, with the above-described conventional configuration, when a new content item is generated by editing, such as combining a plurality of content items or trimming part of a content item, information of an author, a person of portrait, and so on continues to increase, which is likely to pose a problem that the information is migrated as being inaccurate, for example.

In addition, when a plurality of persons perform an editing operation via the network in an SNS or the like, there is a problem that content information to be migrated become further inaccurate and complicated.

In addition, the association is unclear between (i) the content item newly generated by combining a plurality of content items, making use of parts of a content item, and the like, and (ii) an original content item which is a base of the newly generated content item, and thus there is a problem that it is difficult to trace the original content item.

An aspect of the present invention has been conceived in view of the problems described above, and the present invention has an object to provide a communication terminal and the like which are capable of properly managing the relationship between a large number of content items.

In order to solve the above-described problem, a content managing apparatus according to a first aspect of the present invention is a content managing apparatus for managing a content item using a storage unit including a content information management region and an operation history management region, the content managing apparatus including: a content information editing unit configured to newly add first content information for identifying a first content item to the content information management region; an operation history information editing unit configured to add, to the operation history management region, first operation history information indicating history of an editing operation performed on the first content item, when second content information for identifying a second content item used in the editing operation performed on the first content item is stored in the storage unit; and an associating unit configured to store (i) information indicating a parent-child relationship between the first content item and the second content item and (ii) information for associating the first operation history information with the first content information and the second content information, into an association management region included in each of the first content information and the second content information in the content information management region, when the first operation history information is added by the operation history information editing unit.

According to this configuration, it is possible to implement a communication terminal capable of properly managing a relationship between a large number of content items.

More specifically, the content managing apparatus according to the first aspect (i) holds relationship information between content data items, in a content management region, (ii) holds operation history information indicating a relationship of editing operation between the content data items, in an operation history management region, and (iii) holds a relationship of a content item and an editing operation, in an association management region. As described above, a configuration is implemented which can perform a characteristic data holding method on a plurality of content items, thereby making it possible to obtain information on a base content item and properly manage the information even when a content item is newly generated by combining a plurality of content items, trimming part of a content item, and the like.

In addition, in the content managing apparatus according to a second aspect, for example, when receiving at least (i) first information for identifying the first content item and (ii) second information indicating the history of the editing operation performed on the first content item from a first communication apparatus connected to the content managing apparatus, the content information editing unit may newly add the first content information to the content information management region according to the first information received from the first communication apparatus.

In addition, in the content managing apparatus according to a third aspect, the operation history information editing unit may, in the second aspect, for example, search the storage unit for the second content information according to the first information and the second information; and, when the second content information is present, newly add the first operation history information to the operation history management region according to the second information.

In addition, in the content managing apparatus according to a fourth aspect, the content information editing unit may, for example, newly add, according to the first information, at least (i) an identifier indicating the first content item and (ii) an identifier indicating the first communication apparatus holding the first content item, as the first content information, to the content information management region.

In addition, in the content managing apparatus according to a fifth aspect, the operation history information editing unit may, for example, newly add, according to the second information, at least (i) an identifier indicating the editing operation and (ii) information for associating the editing operation with the second content information, as the first operation history information, to the operation history management region.

In addition, the content managing apparatus according to a sixth aspect, for example, may further include a content holding unit configured to hold a content item, wherein the content holding unit may hold the first content item when receiving the first content item from the first communication apparatus.

In addition, in the content managing apparatus according to a seventh aspect, in any one of the first aspect to sixth aspect, the editing operation may, for example, include an operation for generating the first content item by replicating the second content item.

In addition, in the content managing apparatus according to an eighth aspect, in any one of the first aspect to the seventh aspect, the editing operation may, for example, include an operation for generating the first content item by trimming the second content item.

Here, in the content managing apparatus according to the ninth aspect, in any one of the first aspect to the seventh aspect, for example, the second content item may include a plurality of content items different from each other, the editing operation may include an operation for generating the first content item by editing the plurality of content items, and the associating unit may store (i) information indicating a parent-child relationship between the first content item and each of the plurality of content items and (ii) information for associating the first operation history information with the first content information and each of the plurality of content items, into the association management region which is provided in the content information management region and is included in each of the first content information and information of each of the plurality of content items.

In addition, in the content managing apparatus according to a tenth aspect, in any one of the second aspect to the seventh aspect, for example, the editing operation may include an operation for generating the first content item by receiving, by the first communication apparatus, a replica of the second content item held by a second communication apparatus connected to the content managing apparatus, and the content information management region may hold, as the second content information, (i) an identifier indicating the second content item and (ii) an identifier indicating the second communication apparatus holding the second content item.

In addition, in the content managing apparatus according to an eleventh aspect, in any one of the first aspect to the fourth aspect, for example, when receiving deletion history information from the first communication apparatus, the content information editing unit may further delete the first content information from the content information management region in the storage unit, the deletion history information indicating history of an editing operation of deleting the first content item, the operation history information editing unit may further delete the first operation history information from the operation history management region when the first operation history information is stored in the operation history management region, and the associating unit may further delete (i) information associated with the first content information and (ii) information associated with the first operation history information, from the association management region which is provided in the content information management region and is included in the first content information and the second content information.

In addition, in the content managing apparatus according to a twelfth aspect, in the second aspect, for example, the content managing apparatus may further include a restoration executing unit configured to execute restoration of the first content item using information held in the content information management region and the operation history management region when a restoration request for the first content item which the first communication apparatus has lost is received from the first communication apparatus.

In addition, in the content managing apparatus according to a thirteenth aspect, in the twelfth aspect, for example, the reconstruction executing unit may include: a checking unit which performs checking by searching the content information management region and the operation history management region which include the association management region in which the second content information identified based on the first content information and the second operation history information including the second content information are present; and an executing unit may, when the checking unit has confirmed that the second content information and the second operation history information are present, restore the first content item of the first communication apparatus, by causing a second communication apparatus to transmit the second content item based on the second operation history information, the second communication apparatus being indicated by the second content information and connected to the content managing apparatus.

In addition, in the content managing apparatus according to a fourteenth aspect, in the twelfth aspect, for example, the content managing apparatus may further generate and hold a thumbnail of the first content item, and the restoration executing unit may execute restoration of the first content item using the thumbnail, when receiving a restoration request for the first content item which the first communication apparatus has lost is received from the first communication apparatus.

In addition, in the content managing apparatus according to a fifteenth aspect, in the second aspect, for example, the content managing apparatus may further include a data migration executing unit which executes data migration by transmitting a content item held by the first communication apparatus to a second communication apparatus connected to the content managing apparatus, using information held in the content information management region and the operation history management region, when receiving, from the second communication apparatus, a migration request for migration of data including a content item held by the first communication apparatus.

In addition, in order to solve the above-described problems, the content managing method according to the present invention is a content managing method including managing information items including (i) first content information for identifying a first content item, (ii) second content information for identifying a second content item used in an editing operation performed on the first content item, (iii) information indicating a parent-child relationship between the first content item and the second content item, and (iv) information for associating the first operation history information with the first content information and the second content information, the first operation history information indicating history of the editing operation performed on the first content item, and when a transmission request for the first content item is received from the first communication apparatus, transmitting at least one of the first content item and the second content item to one of the first communication apparatus and the second communication apparatus, using the information items managed in the managing.

Here, for example, the transmission request may be a restoration request for restoring the first content item which the first communication apparatus has lost, and in the transmitting, when the restoration request is received from the first communication apparatus, (i) the first content item held by the second communication apparatus or the content managing apparatus, or (ii) a content item generated by the editing operation performed on the first content item may be transmitted to the first communication apparatus, as restoration processing for the first content item.

Here, for example, the transmission request may be a migration request demanding migration of data including the content item held by the first communication apparatus, to the second communication apparatus, and in the transmitting, when the migration request is received from the first communication apparatus, the data held by the first communication apparatus may be transmitted to the second communication apparatus, as processing of the migration.

It is to be noted that Embodiments described below each indicate one specific example of the present invention. The numerical values, shapes, materials, structural elements, the arrangement and connection of the structural elements, steps, the processing order of the steps etc. shown in the following embodiments are mere examples, and therefore do not limit the scope of the present invention. In addition, among the structural elements in the following embodiments, structural elements not recited in any one of the independent claims are described as arbitrary structural elements.

The following describes Embodiments of the present invention with reference to the drawings.

### Embodiment 1

The following describes a content managing server and a terminal apparatus according to Embodiment 1 of the present invention.

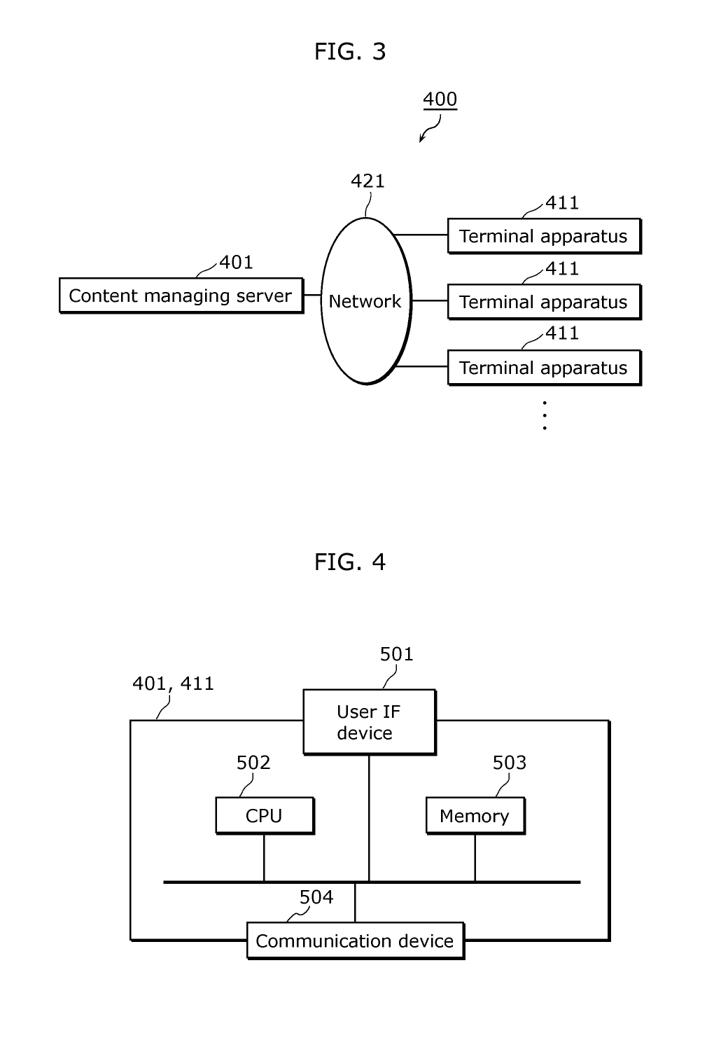

FIG. 3 is a configuration diagram of a content management system according to Embodiment 1. FIG. 4 is a diagram illustrating an example of a hardware configuration of a content managing server 401 and a terminal apparatus 411 according to Embodiment 1.

A content management system 400 illustrated in FIG. 3 includes a content managing server 401 and a plurality of terminal apparatuses 411, which are connected to a network 421.

The network 421 may be the Internet (public network) or may be a local network.

The details of the content managing server 401 and the terminal apparatuses 411 will be described later, and the content managing server 401 and the terminal apparatuses 411 are implemented by the hardware configuration as illustrated in FIG. 4. More specifically, the content managing server 401 and the terminal apparatuses 411 include: a user interface (IF) device 501; a central processing unit (CPU) 502; a memory 503; and a communication device 504. Here, the user IF device 501 includes: an input device such as a button, a keyboard, a mouse, and so on; and an output device such as a display, an LED, and so on. The communication device 504 is a communication device such as a wired local area network (LAN), Wi-Fi, ZigBee, and so on.

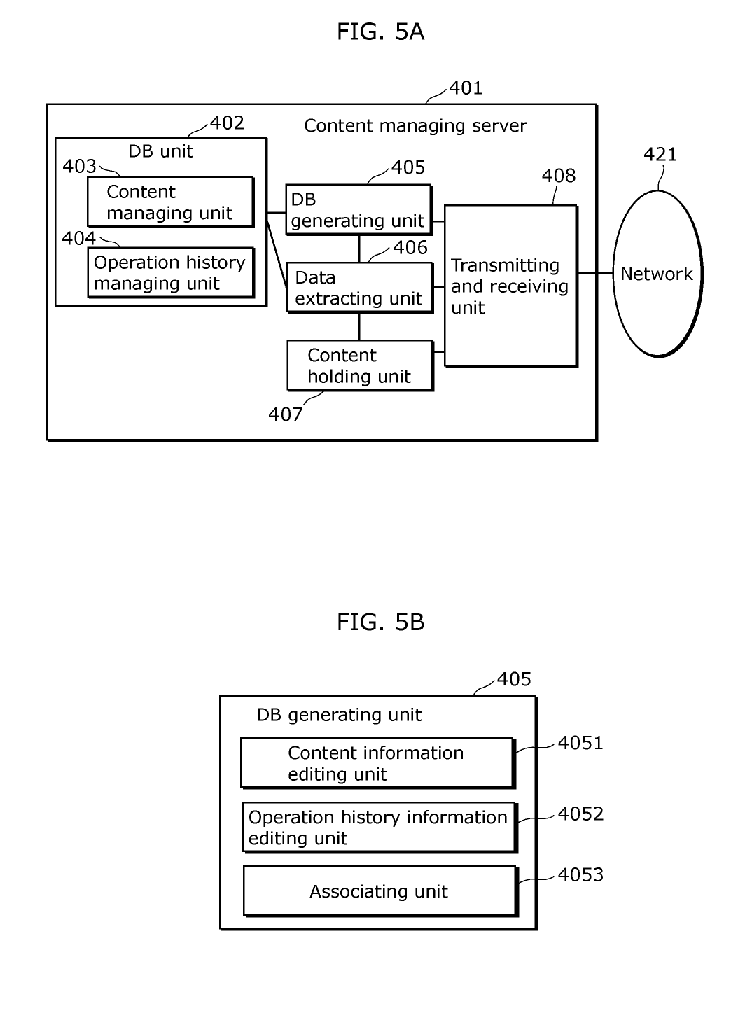

The following describes details of a configuration of the content managing server 401 according to Embodiment 1, with reference to FIG. 5A and FIG. 5B.

FIG. 5A is a block diagram illustrating an example of a configuration of the content managing server according to Embodiment 1. FIG. 5B is a block diagram illustrating an example of a detailed configuration of a DB generating unit 405 according to Embodiment 1.

As illustrated in FIG. 5A, the content managing server 401 is an example of the content managing apparatus, for example, and includes: a DB unit 402 including a content managing unit 403 and an operation history managing unit 404, a DB generating unit 405; a data extracting unit 406; a content holding unit 407; and a transmitting and receiving unit 408.

The transmitting and receiving unit 408 transmits and receives data to and from the network 421. For example, the transmitting and receiving unit 408 receives first information (content information) for identifying a first content item and second information (operation history information) for indicating history of editing operations performed on the first content item, from the terminal apparatuses 411 (an example of the first communication apparatus).

The DB unit 402 includes the content managing unit 403 and the operation history managing unit 404, and data indicating a relationship between a plurality of content items is held therein by registration (storage) of content information, operation history information, and the like, performed by the DB generating unit 405. The DB unit 402 may be a storage unit including, for example, a memory or the like.

The content managing unit 403 includes a content information management region in which content information for identifying a content item is included. In addition, in the content managing unit 403, i.e. the content information management region, information indicating a parent-child relationship between content items, and information which associates content information with operation history information are registered, for each item of the content information. Hereafter, the region in which information which associates content information with operation history information are registered in the content information management region is called an association management region.

In the content information management region, information such as a content ID, an ID of the terminal apparatus 411 which holds a content corresponding to the content ID, a path for holding content items in the terminal apparatus 411, are held, for example. In addition, the association management region holds parent data information and child data information of a content item held in the content information management region. Here, the parent data is information associating a base content item and a content item when the content item is generated by replicating, editing, or the like the base content item. The child data is information associating a given content item and a new content item when the new content item is generated by replicating or editing the given content item. It is to be noted that an operation example of the content managing unit 403 and the operation history managing unit 404 will be described later in Examples.

As illustrated in FIG. 5B, the DB generating unit 405 includes: a content information editing unit 4051; an operation history information editing unit 4052; and an associating unit 4053, receives the content information and the operation history information which have been obtained from the transmitting and receiving unit 408 in accordance with an instruction of the data extracting unit 406, and edits information managed in the content managing unit 403 and the operation history managing unit 404.

The content information editing unit 4051 newly adds, to the content managing unit 403, first content information that is information for identifying the first content item. In addition, the content information editing unit 4051 deletes the first content information from the content managing unit 403 in accordance with the command of the data extracting unit 406 when receiving, from the terminal apparatus 411, deleting history information indicating the history of an editing operation by which the first content item has been deleted.

For example, the content information editing unit 4051, when receiving, from the terminal apparatus 411, at least: the first information for identifying the first content item; and the second information for indicating the history of an editing operation performed on the first content item, newly adds, to the content managing unit 403, the first content information according to the received first information. Here, the content information editing unit 4051 newly adds, to the content managing unit 403, at least: an identifier indicating the first content item; and an identifier indicating the terminal apparatus 411 which holds the first content item, for example, as the first content information, according to the first information.

It is to be noted that the editing operation is, for example, an operation for generating a content item by replication (an operation for generating the first content item by replicating the second content item, in the above-described example) and an operation for generating a new content item by trimming a given content, for example, (an operation for generating the first content item by trimming the second content item, in the above-described example). In addition, the editing operation includes, for example, an operation for generating the first content item by editing a plurality of content items. Furthermore, the editing operation includes, for example, an operation performed by a given terminal apparatus 411 (a terminal apparatus A, for example) connected to the content managing server 401 to generate the first content item by receiving a replica of the second content item held by a different terminal apparatus 411 (a terminal apparatus B, for example) connected to the content managing server 401. In addition, the editing operation includes an operation for deleting a content item, for example.

Here, the case is assumed where, for example, the content information (the second content information in the above-described example) that is the information for identifying a content item (the second content item in the above-described example) used in an editing operation performed on a given content item (the first content item in the above-described example) is stored (held) in the DB unit 402, in this case, the operation history information editing unit 4052 newly adds, to the operation history managing unit 404, first operation history information that is the information for indicating history of editing operation performed on a given content item (the first content item), according to an instruction issued by the data extracting unit 406. In addition, the operation history information editing unit 4052 deletes the first operation history information from the operation history managing unit 404 according to the instruction of the data extracting unit 406 when the content information editing unit 4051 deletes the first content information from the content managing unit 403 and the first operation history information is stored (held) in the operation history managing unit 404.

For example, the operation history information editing unit 4052, when searching for the second content information in the DB unit 402 according to the first information and the second information to find out that the second content information is present, newly adds the first operation history information to the operation history managing unit 404 according to the second information. Here, the operation history information editing unit 4052 newly adds, to the operation history managing unit 404, at least: the identifier indicating the above-described editing operation; and the information that associates the above-described editing operation with the second content information, for example, as the first operation history information, according to the second information.

The associating unit 4053 stores (i) information indicating the parent-child relationship between the first content item and the second content item, and (ii) information that associates the first operation history information with the first content information and the second content information, into the association management region included in each of the first content information and the second content information of the content managing unit 403.

In addition, the associating unit 4053, when the content information editing unit 4051 deletes the first content information from the content managing unit 403 and the information associated with the first content information is stored (held) in the content managing unit 403, for example, deletes (i) information with which the first content information is associated and (ii) information with which the first operation history information is associated, in the association management region included in the first content information and the second content information.

It is assumed, for example, that a given content item (the second content item in the above-described example) includes a plurality of different content items, and the above-described editing operation is an operation for generating a new content item (the first content item in the above-described example) by editing the plurality of content items. In this case, the associating unit 4053 stores (i) information indicating the parent-child relationship between the first content item and each of the plurality of content items, and (ii) information that associates the first operation history information to each of the first content information and the plurality of content items, into the association management region included in each of the first content information and the plurality of items of content information in the content managing unit 403.

The content holding unit 407 holds a content item. More specifically, the content holding unit 407 holds content data obtained from the transmitting and receiving unit 408 or content data generated by the data extracting unit 406. For example, the content holding unit 407, when receiving the first content item from the terminal apparatus 411, may hold the received first content item. It is to be noted that the content data held by the content holding unit 407 may be data of the content item itself, data which is compressed, or data which is reduced such as thumbnail.

It is to be noted that the above-described the configurations are each implemented using a hardware configuration such as the above-described CPU, a memory, and a communication device.

The content managing server 401 is configured as described above.

Next, the configuration of the terminal apparatus 411 according to Embodiment 1 will be described in detail.

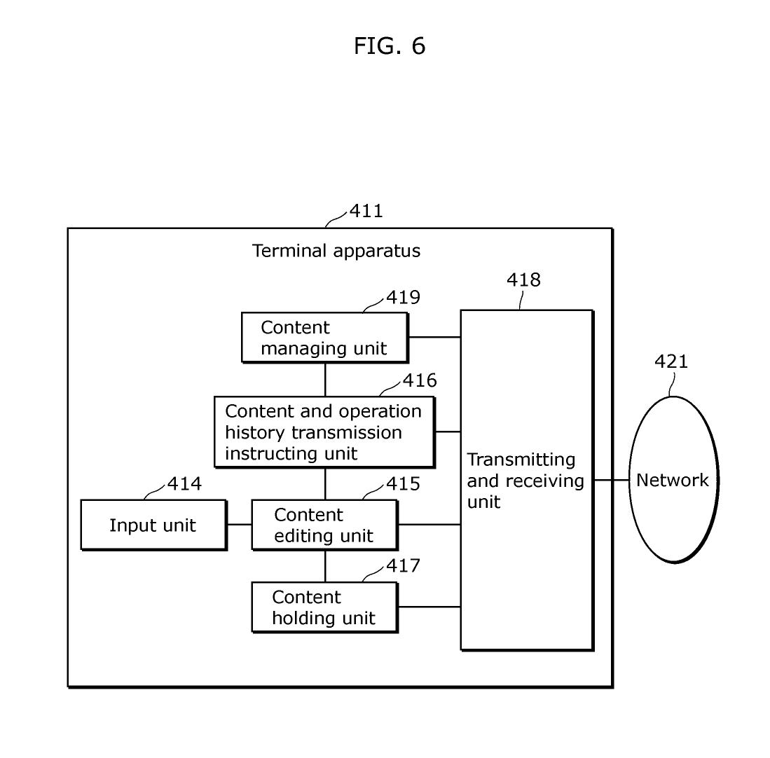

FIG. 6 is a block diagram illustrating an example of a configuration of the terminal apparatus 411 according to Embodiment 1.

As illustrated in FIG. 6, the terminal apparatus 411 is connected to the content managing apparatus, and includes: an input unit 414; a content editing unit 415; a content and operation history transmission instructing unit 416; a content holding unit 417; a transmitting and receiving unit 418; and a content managing unit 419.

The transmitting and receiving unit 418 transmits and receives data to and from the network 421. For example, the transmitting and receiving unit 418 transmits the first information (content information) for identifying a first content item and second information (operation history information) for indicating history of editing operation performed on the first content item, to the content managing server 401. It is to be noted that the transmitting and receiving unit 418 may receive a content item held in a different terminal apparatus 411. Here, one terminal apparatus 411 is an example of the first communication apparatus, for example, and the different terminal apparatus 411 is an example of the second communication apparatus, for example.

The content editing unit 415 uses a content item obtained from the network 421 via the content holding unit 417 and the transmitting and receiving unit 418. The content editing unit 415 performs the editing operation for generating a new content item (the first content item in the above-described example) by replicating a content item (the second content item in the above-described example) according to an instruction of a user (the input unit 414 to which the instruction of a user has been provided), for example. The content editing unit 415 performs the editing operation for generating a new content item (the first content item in the above-described example) by trimming a given content item (the second content item in the above-described example). In addition, the content editing unit 415 performs the editing operation for generating a new content item (the first content item in the above-described example) by editing a plurality of content items.

The content editing unit 415 causes the content holding unit 417 to hold the data of the edited content item itself, and stores the content information of the content item into the content managing unit 419.

When the content editing unit 415 edits a content item and the edited content item is stored into the content holding unit 417, the content and operation history transmission instructing unit 416 temporarily holds operation history information of the operations performed through the editing of the content item. The content and operation history transmission instructing unit 416 instructs the transmitting and receiving unit 418 to transmit, together with the content information stored in the content managing unit 419, the operation history information which is held, to the content managing server 401 connected to the network 421. With this, the terminal apparatus 411 registers, on the content managing server 401, the content information of the edited content item and the operation history information thereof.

It is to be noted that the content and operation history transmission instructing unit 416 need not necessarily issue the instruction of transmitting the content information and the operation history information to the content managing server 401, immediately after the content item is edited by the content editing unit 415. It may be issued when the terminal apparatus 411 is in the idle state, or when items of the content operation history are accumulated to some extent. In this case, an advantageous effect is produced that the terminal apparatus 411 need not necessarily be constantly connected to the network 421.

The content holding unit 417 holds the content data (content itself) obtained from the transmitting and receiving unit 418, and the content data generated by the editing or replication in the content editing unit 415.

The content managing unit 419 manages and holds the content information obtained from the transmitting and receiving unit 418, and the new content information generated by the editing or replication in the content editing unit 415.

It is to be noted that the above-described configurations are each implemented using a hardware configuration such as the CPU, the memory, and the communication device of each of the terminal apparatuses 411.

The terminal apparatus 411 is configured as described above.

The following describes the operations of the content managing server 401 and the terminal apparatus 411 described above.

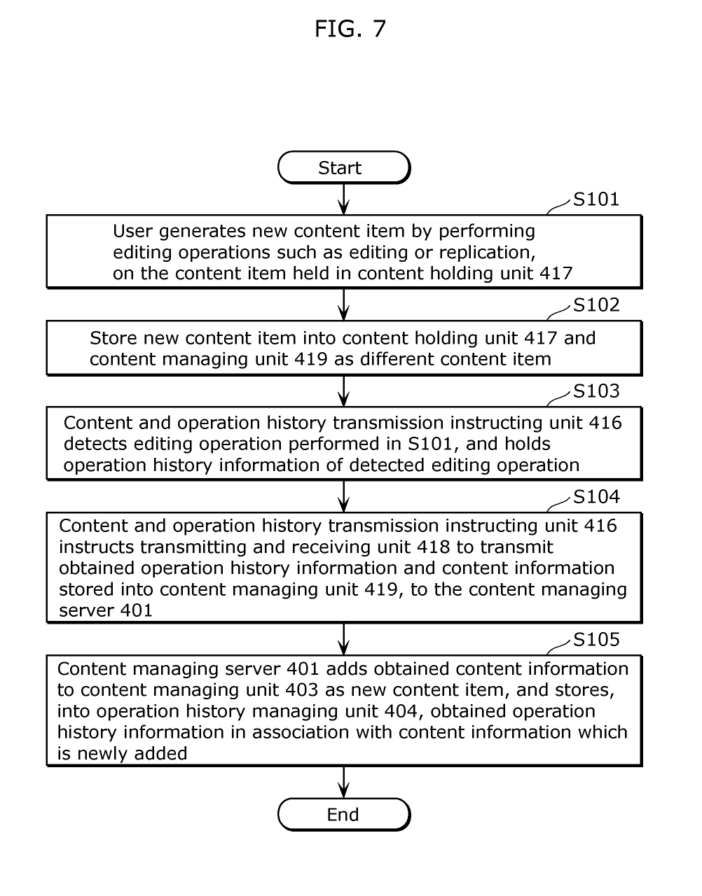

FIG. 7 is a diagram for explaining an outline of processing when data management is performed using the content management system according to Embodiment 1.

First, a user generates a new content item by performing the editing operations such as the editing or replication, on the content item held in the content holding unit 417 in the terminal apparatus 411, using the input unit 414 and the content editing unit 415 (S101).

Then, the content editing unit 415 stores, as a different content item, the content item generated by editing or replication, into the content holding unit 417 and the content managing unit 419 (S102).

Next, the content and operation history transmission instructing unit 416 of the terminal apparatus 411 detects the editing operation performed in S101, and holds the operation history information of the detected editing operation (S103). Here, the operation history information of the detected editing operation is information indicating the operation history of the time when a new content is generated.

Next, the content and operation history transmission instructing unit 416 instructs the transmitting and receiving unit 418 to transmit the operation history information obtained in S102 and the content information stored into the content managing unit 419 in S101, to the content managing server 401 (S104).

Next, the content managing server 401 receives the operation history information and the content information transmitted from the terminal apparatus 411 in S103. The content managing server 401 adds the obtained content information to the content managing unit 403 as a new content item, and stores, into the operation history managing unit 404, the obtained operation history information in association with the content information which is newly added (S105).

As described above, the operations performed by the terminal apparatus 411 and the content managing server 401 make it possible not only to manage, by the content managing server 401, the content item generated by editing or replication in the terminal apparatus 411, but also to properly migrate the content information. In addition, since the association with the content item which is the base can be held, it is possible to properly manage the relationship between a large number of content items.

The following describes main operations performed by the terminal apparatus 411 and the content managing server 401, as Examples.

### Example 1

### Replication of a Content Item in the Terminal Apparatus

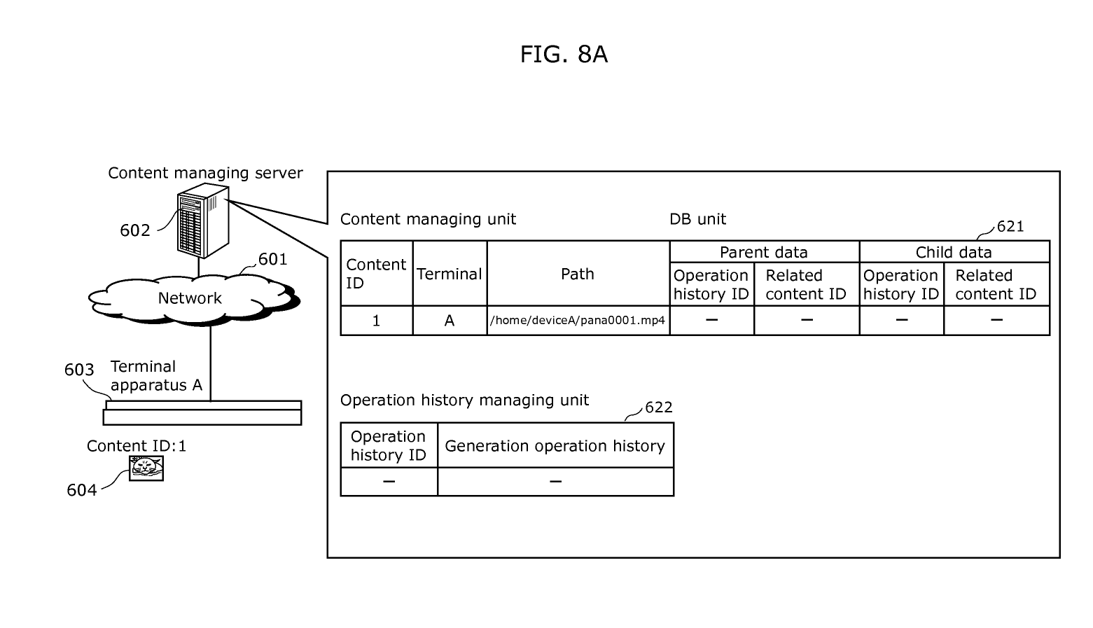

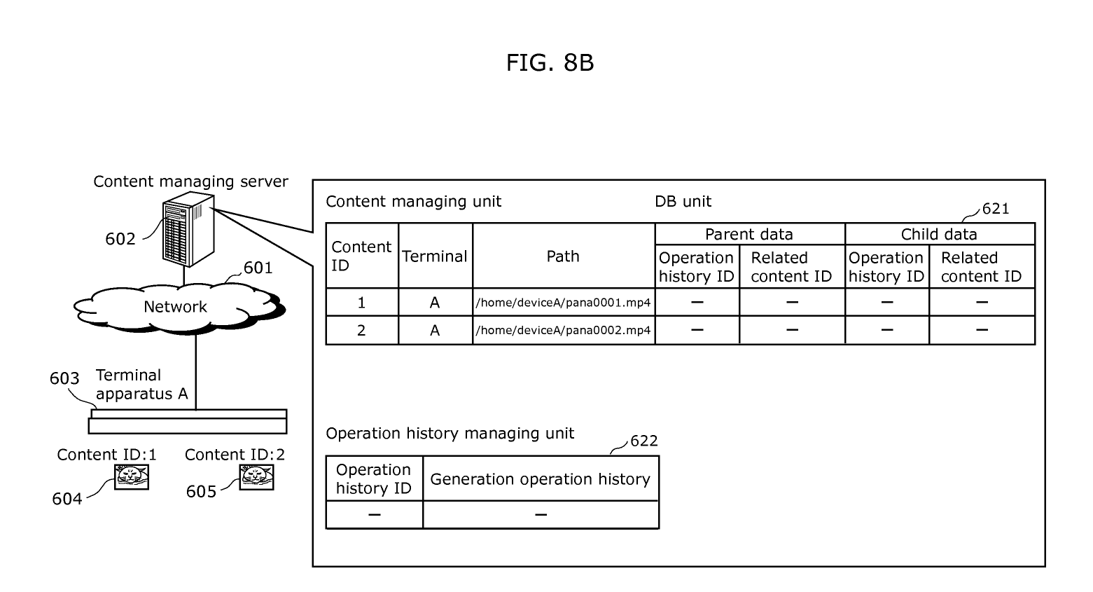

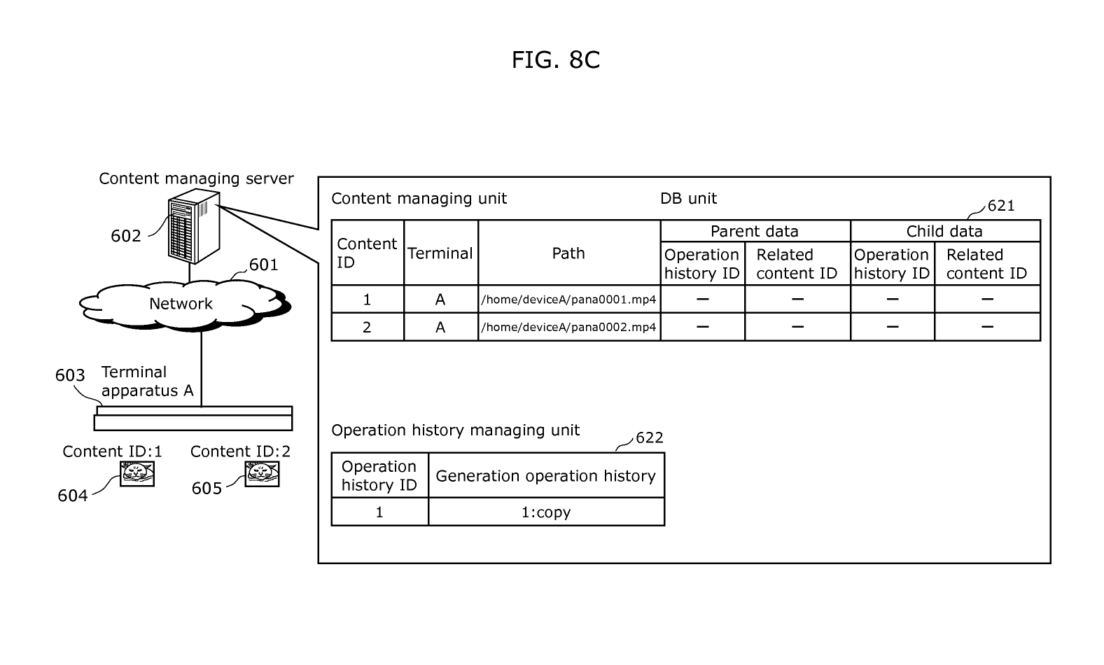

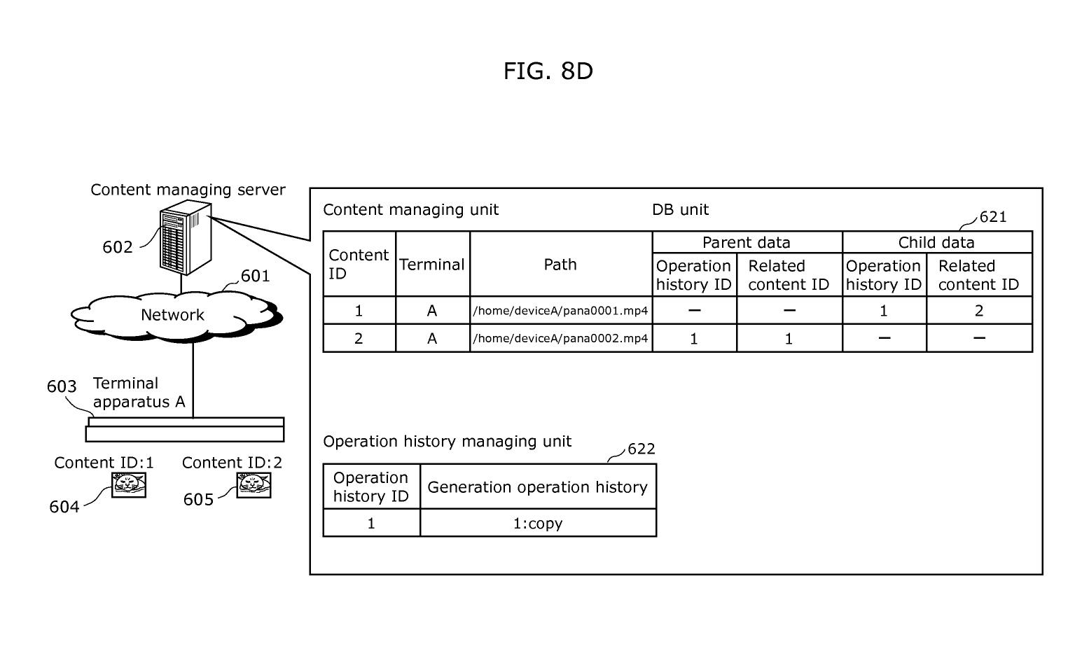

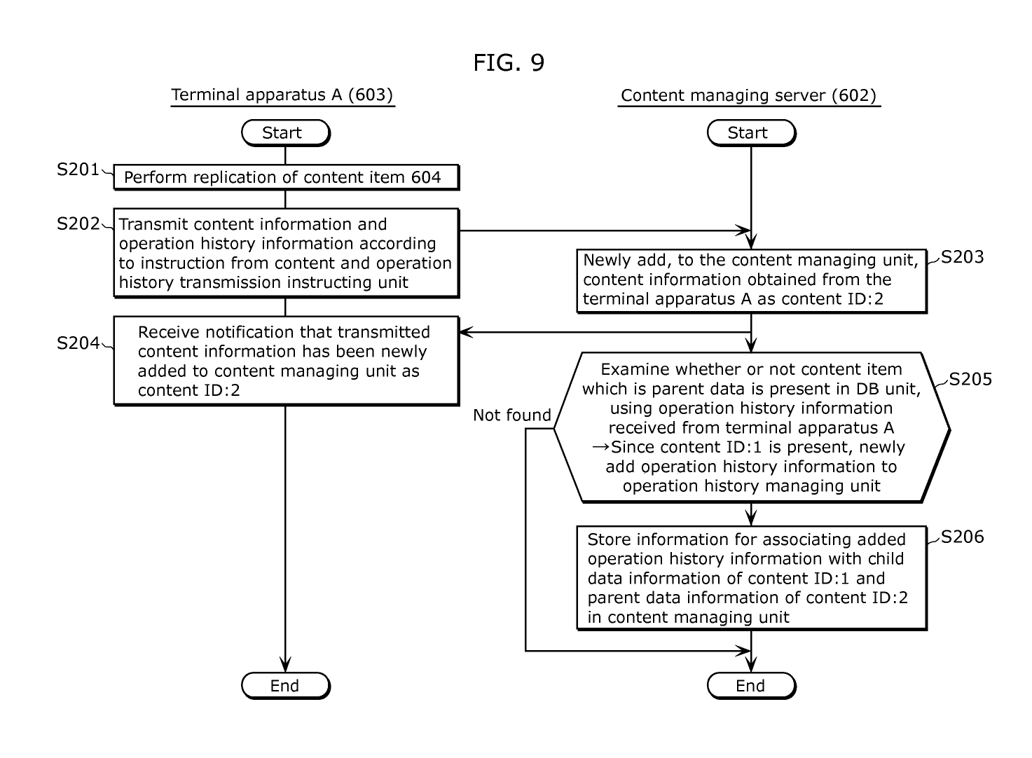

FIG. 8A to FIG. 8D are diagrams for explaining the operations of Example 1 according to Embodiment 1. FIG. 9 is a diagram illustrating the operation sequence of Example 1 according to Embodiment 1. FIG. 8A illustrates an example of a data management state prior to executing content replication in a terminal apparatus, which is an operation of Example 1. FIG. 8B and FIG. 8C illustrate examples of a data management state in the content managing server subsequent to executing content replication in a terminal apparatus, which is an operation of Example 1. FIG. 8D illustrates an example of a data management state subsequent to data management processing.

It is to be noted that the content managing server 602 illustrated in FIG. 8A to FIG. 8D is a server including the configuration of the content managing server 401 described in Embodiment 1, and which is an aspect of the content managing server 401. In addition, a terminal apparatus 603 (terminal apparatus A) illustrated in FIG. 8A to FIG. 8D is a terminal which includes the configuration of the terminal apparatus 411 described in Embodiment 1, and which is an aspect of the terminal apparatus 411. In addition, the network 601 is an aspect of the network 421 described above.

The following describes data management processing at the time of replication of a content item performed by the terminal apparatus 411, as an example of the operation described in Example 1. More specifically, the following describes an operation of the content managing server when an editing operation for generating a content item 605 is performed by replicating, in the terminal apparatus 603, a content item 604 identified by a content ID:1 stored in the terminal apparatus 603 (the terminal apparatus A).

First, the terminal apparatus 603 (the terminal apparatus A) replicates the content item 604 in the terminal apparatus, and performs the editing operation for generating the content item 605 (S201).

Then, the terminal apparatus 603 detects S201 by the content and operation history transmission instructing unit 416, sends an instruction to the transmitting and receiving unit 418, and transmits content information and operation history information to the content managing server 602 (S202)

Here, the content information transmitted to the content managing server 602 from the terminal apparatus 603 is “/home/diviceA/pana0002.mp4” which is a location path of a content item identified by an ID:1 which is an ID of a terminal, for example. In addition, the operation history information is “1:copy” which is operation history of an operation performed for generating the content 605, for example. “1:copy” is a combination of an ID of an original content item and an operation thereof, and denotes “a content ID: performed operation” It is to be noted that each of the content information and the operation history information transmitted to the content managing server is an example, and may be referred to by other expressions. Further, in addition to these content information and operation history information, other information may be transmitted.

Next, the content managing server 602 newly adds, to the content managing unit 403, the content information obtained from the terminal apparatus 603 as a content ID:2, as illustrated in FIG. 8B (S203). At this time, no information is stored into the items of the parent data and the child data (association management region) of the content ID:2 in the content managing unit 403 (the content information management region 621). The content managing server 602 notifies the terminal apparatus 603 of the new addition made to the content managing unit 403. Then, the terminal apparatus 603 is notified that the transmitted content information has been newly added to the content managing unit 403 as the content ID:2 (S204).

Next, the content managing server 602 examines whether or not the content item of the content ID:1, which is the parent data, is present (stored) in the content managing unit 403, using the operation history information received from the terminal apparatus 603. When the content item is present, operation history information (“1:copy”, in this case) is newly added to the operation history managing unit 404 (the operation history management region 622) as illustrated in FIG. 8C (S205). It is to be noted that, when the content is not present (not found, in S205), information is not added to the operation history managing unit 404 (the operation history management region 622), and the content management processing is terminated.

Next, since information is added to the operation history managing unit 404 (the operation history management region 622) in S205, the content managing server 602 stores information to be associated with a related content item, such as addition/modification of parent data information and child data information, in the content managing unit 403 (the association management region) (S206). In the present Example, the child data information of the content ID:1 in the content managing unit 403 (the association management region) is rewritten (stored) such that the related content ID, which is the child data, indicates “2” and the operation history ID of the operation performed to generate the child data indicates “1”. In addition, the parent data information of the content ID:2 is rewritten (stored) such that the related content ID, which is the parent data, indicates “1” and the operation history ID of the operation performed to generate the parent data indicates “1”.

As described above, the content management processing is performed which holds (processes by a characteristic procedure) a plurality of items of content related information in a characteristic data structure. This makes it possible not only to manage, in the content managing server 602, a content item generated by replication in the terminal apparatus 603 (terminal apparatus A), but also to manage (use) information on a content item which is a base of the replicated content item and a method (operation history of editing operation) by which the replicated content item is generated (FIG. 8D).

### Example 2

### Content Generation from a Plurality of Content Items

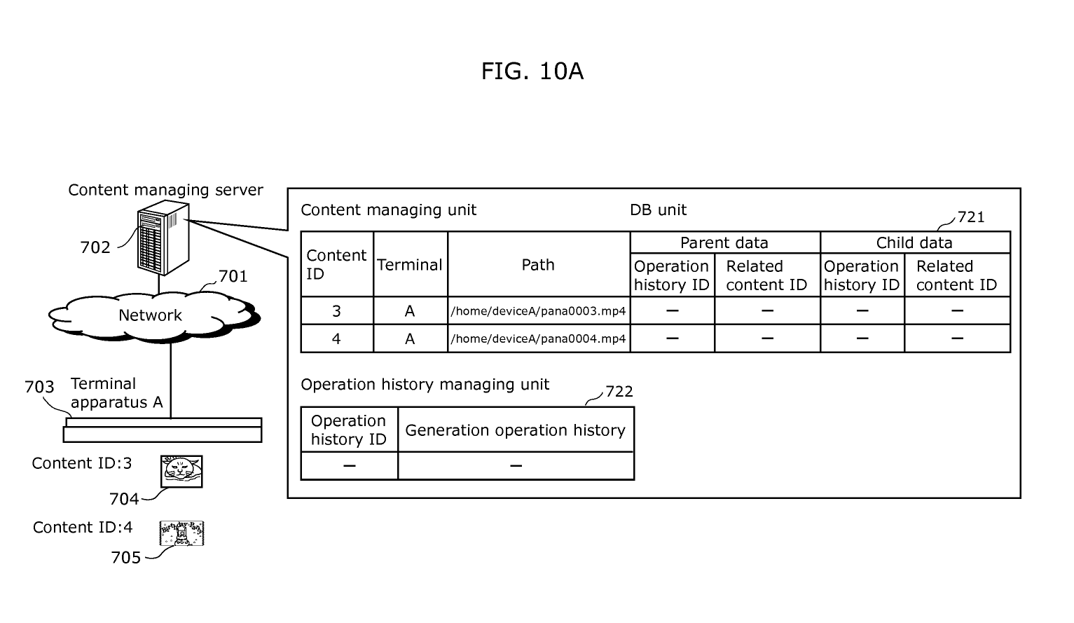

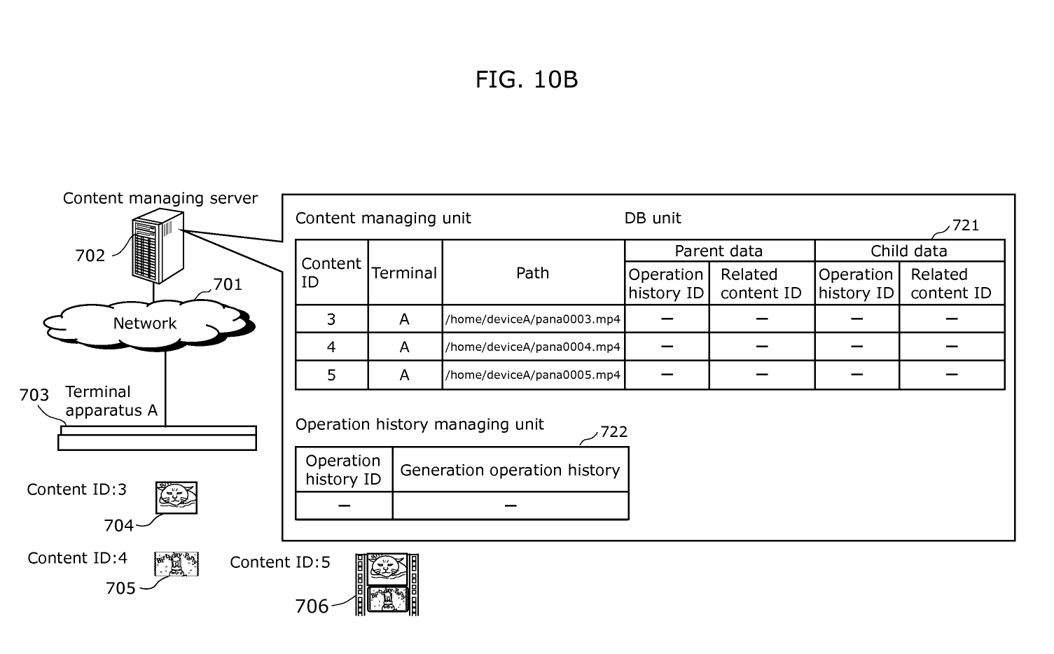

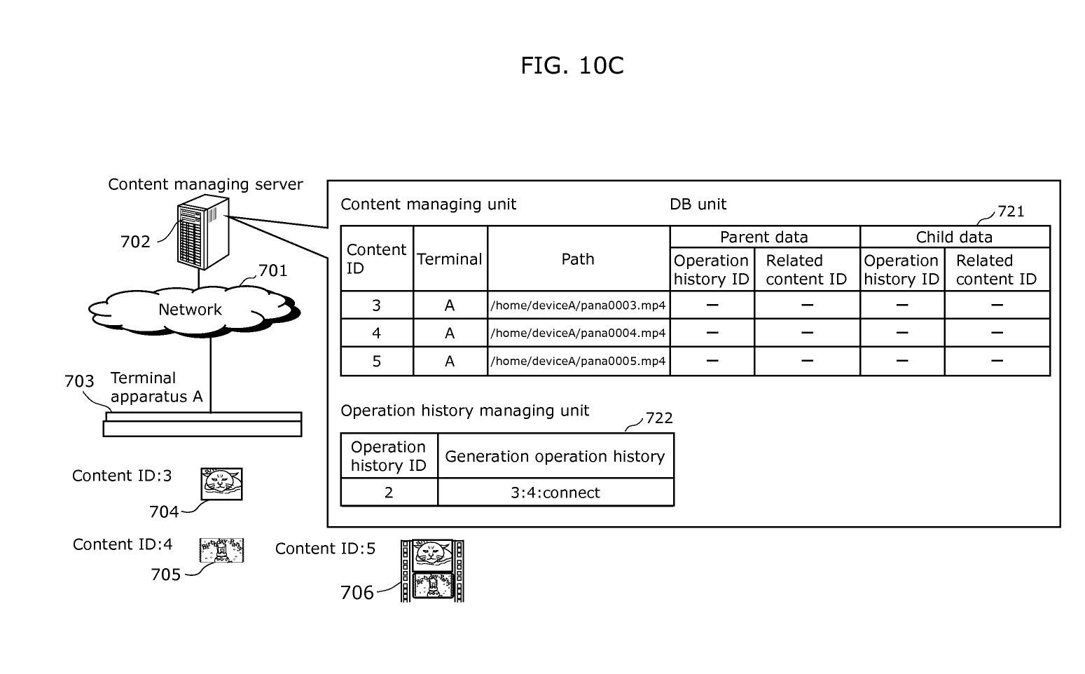

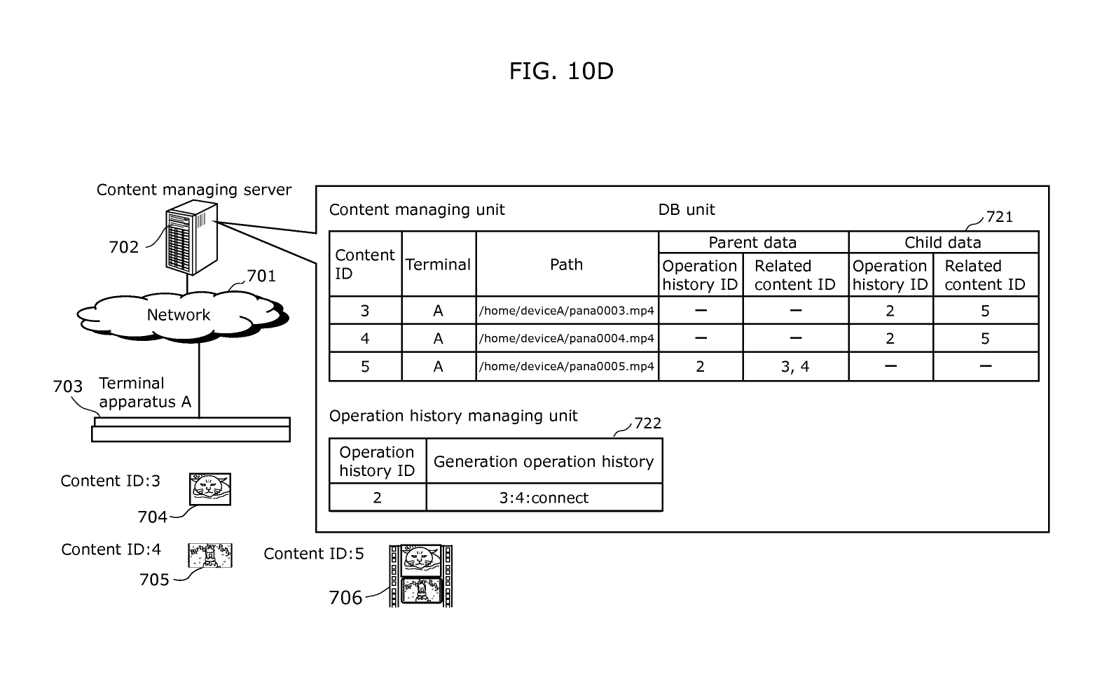

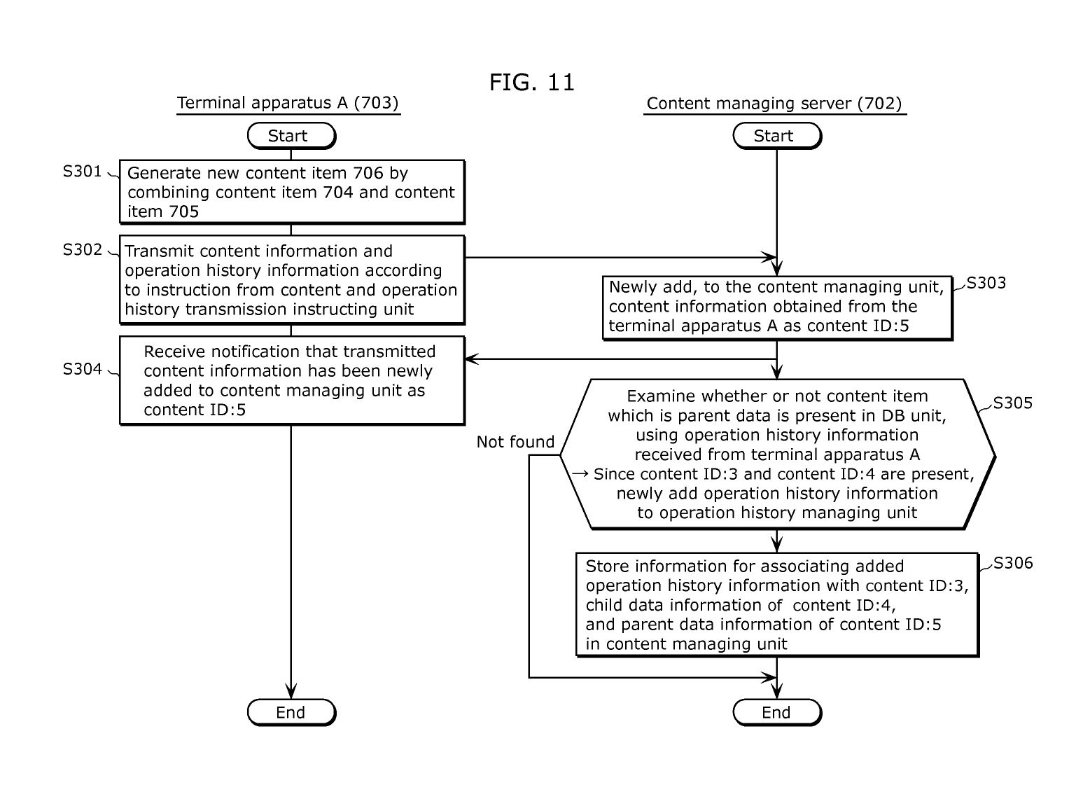

FIG. 10A to FIG. 10D are diagrams for explaining the operations of Example 2 according to Embodiment 1. FIG. 11 is a diagram illustrating the operation sequence of Example 2 according to Embodiment 1. FIG. 10A illustrates an example of a data management state prior to executing content generation from a plurality of content items in a terminal apparatus, which is the operation of Example 2. FIG. 10B and FIG. 10C illustrate examples of a data management state in the content managing server subsequent to executing content generation in a terminal apparatus. FIG. 10D illustrates an example of a data management state subsequent to data management processing.

It is to be noted that a content managing server 702 illustrated in FIG. 10A to FIG. 10D is a server which includes the configuration of the content managing server 401 described in Embodiment 1, and which is an aspect of the content managing server 401. In addition, a terminal apparatus 703 (the terminal apparatus A) illustrated in FIG. 10A to FIG. 10D is a terminal which includes the configuration of the terminal apparatus 411 described in Embodiment 1, and which is an aspect of the terminal apparatus 411. In addition, a network 701 is an aspect of the above-described network 421.

The following describes data management processing at the time of replication of a content item performed by the terminal apparatus 411, as an example of the operation described in Example 2. More specifically, the following describes an operation of the content managing server when an editing operation for generating a content item 706 is performed by combining a content item 704 identified by a content ID:3 and a content item 705 identified by a content ID:4 which are stored in the terminal apparatus 703 (the terminal apparatus A).

First, the terminal apparatus 703 (the terminal apparatus A) performs the editing operation for generating the content item 706 by combining the content item 704 of the content ID:3 and the content item 705 of the content ID:4 (S301).

Then, the terminal apparatus 703 detects S301 by the content and operation history transmission instructing unit 416, sends an instruction to the transmitting and receiving unit 418, and transmits content information and operation history information to the content managing server 702 (S302).

Next, the content managing server 702 newly adds, to the content managing unit 403 (the content information management region 721), the content information obtained from the terminal apparatus 703 as a content ID: 5, as illustrated in FIG. 10B (S303). At this time, no information is stored into the items of the parent data and the child data (association management region) of the content ID:5 in the content managing unit 403 (the content information management region 721). The content managing server 702 notifies the terminal apparatus 703 of the new addition made to the content managing unit 403 of the DB unit 402. Then, the terminal apparatus 703 is notified that the transmitted content information has been newly added to the content managing unit 403 as the content ID:5 (S304).

Next, the content managing server 702 examines whether or not the content items of the content ID:3 and the content ID:4, which are items of the parent data, are present in the content managing unit 403, using the operation history information received from the terminal apparatus 703. When the corresponding content items are present, operation history information (“3:4: connect” in this Example) is newly added to the operation history managing unit 404 (the operation history management region 722), as illustrated in FIG. 10C (S305). It is to be noted that, when the corresponding content items are not present (not found, in S305), information is not added to the operation history managing unit 404 (the operation history management region 722), and the content management processing is terminated.

Next, since information is added to the operation history managing unit 404 (the operation history management region 722) in S305, the content managing server 702 stores information to be associated with a related content item, such as addition/modification of parent data information and child data information, in the content managing unit 403 (the association management region) (S306).

In the present Example, the child data information of the content ID:3 in the content managing unit 403 (the association management region) is rewritten (stored) such that the related content ID, which is the child data, indicates “5” and the operation history ID of the operation performed to generate the child data indicates “2”. In addition, the child data information of the content ID:4 is rewritten (stored) such that the related content ID, which is the child data, indicates “5” and the operation history ID of the operation performed to generate the child data indicates “2”. In addition, the parent data information of the content ID:5 is rewritten (stored) such that the related content ID, which is the parent data, indicates “3, 4” and the operation history ID of the operation performed to generate from the parent data indicates “2”.

As described above, the content management processing is performed which holds (processes by a characteristic procedure) a plurality of items of content related information in a characteristic data structure. This makes it possible to manage, in the content managing server 702, a new content item generated from a plurality of content items in the terminal apparatus 703 (terminal apparatus A), and to manage (use) information on a content item which is a base of the new content item and a generation method thereof (operation history of the editing operation) (FIG. 10D).

### Example 3

### Editing

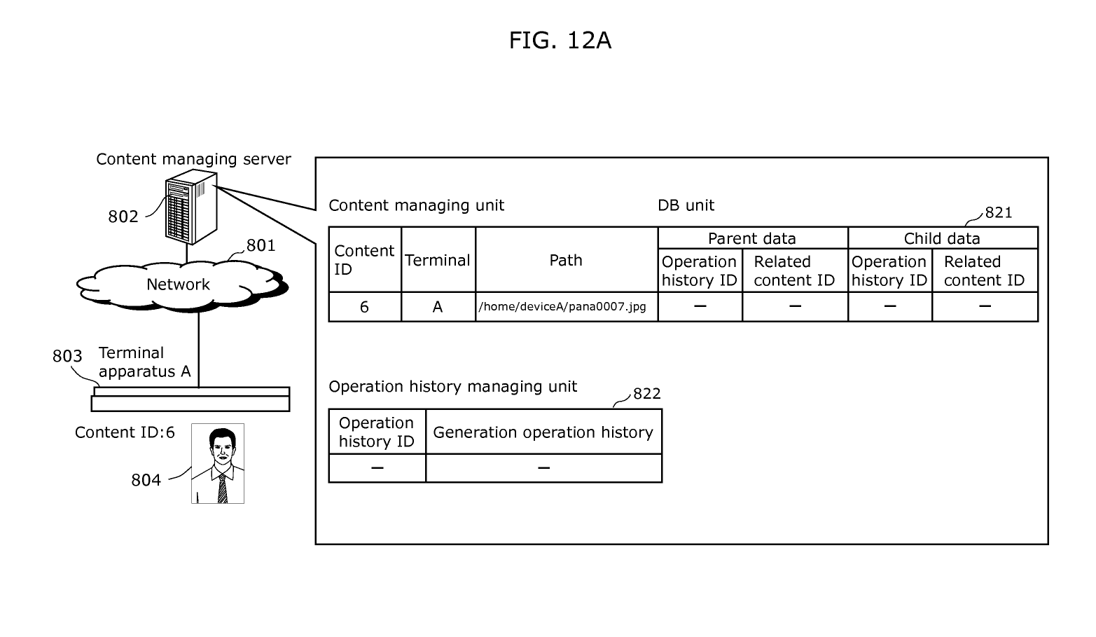

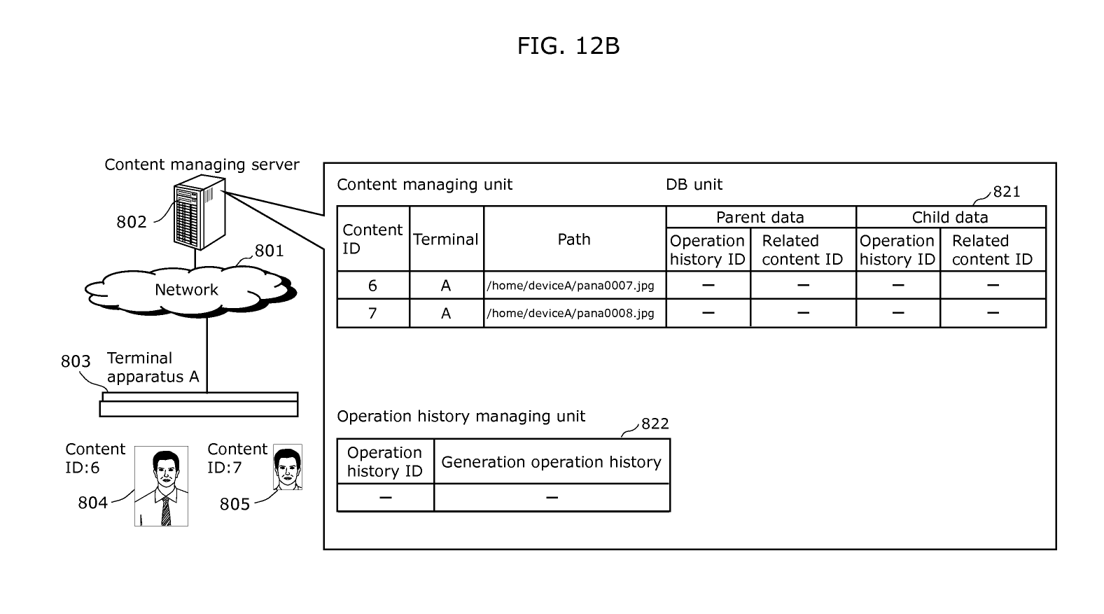

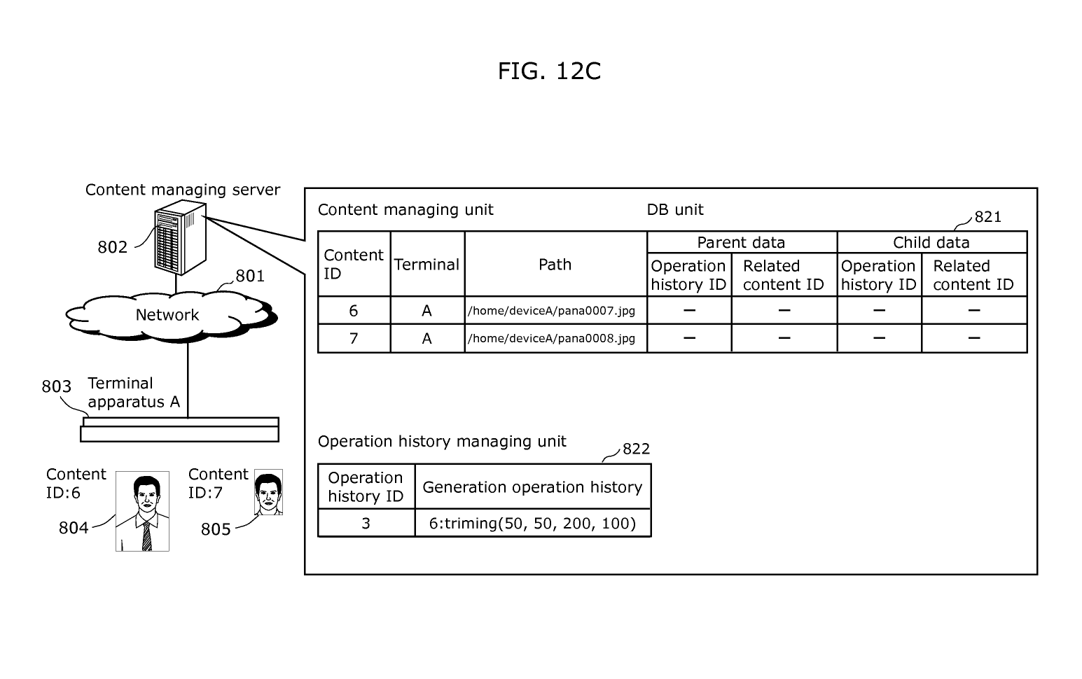

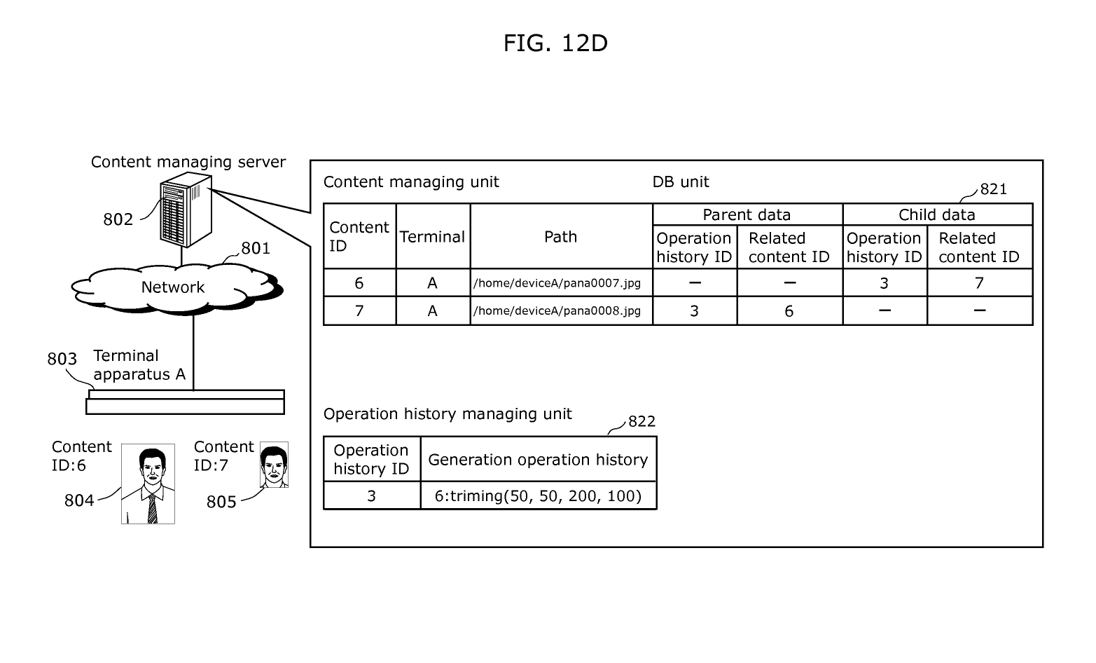

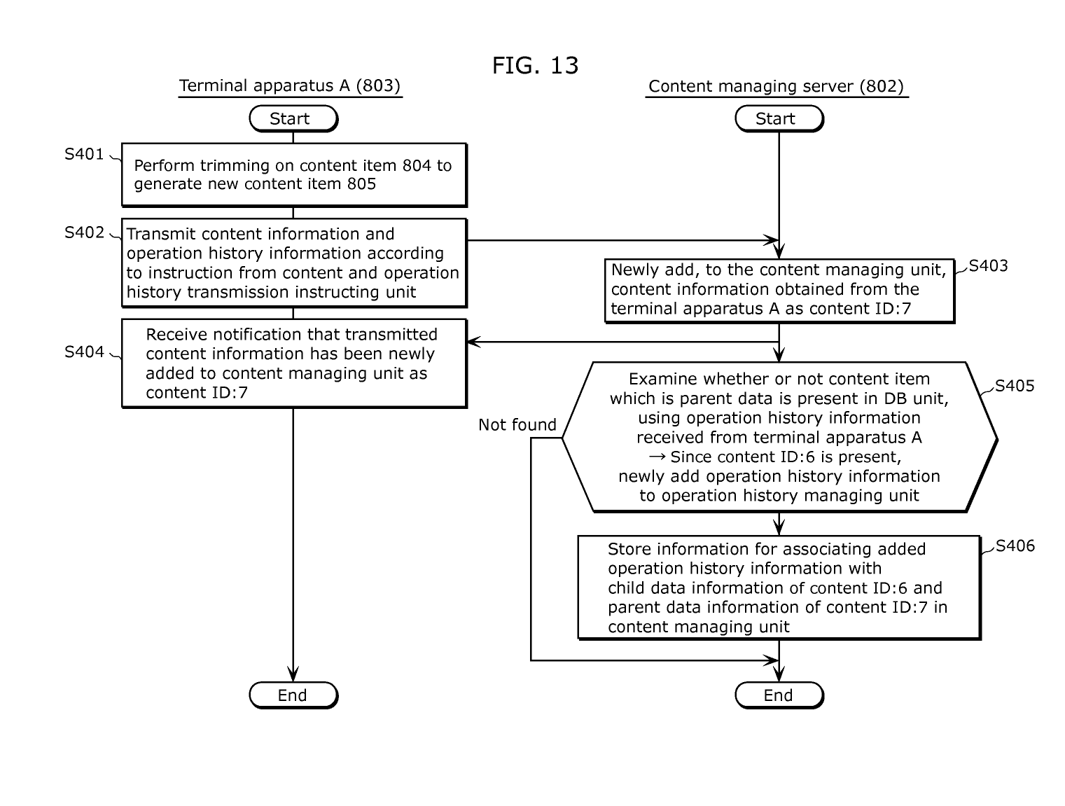

FIG. 12A to FIG. 12E are diagrams for explaining the operations of Example 3 according to Embodiment 1, FIG. 13 is a diagram illustrating the operation sequence of Example 3 according to Embodiment 1, FIG. 12A illustrates an example of a data management state prior to executing an editing operation such as trimming, which is the operation of Example 3, FIG. 12B and FIG. 12C illustrate examples of a data management state in the content managing server subsequent to executing an editing operation. FIG. 12D illustrates an example of a data management state subsequent to data management processing.

It is to be noted that a content managing server 802 illustrated in FIG. 12A to FIG. 12D is a server which includes the configuration of the content managing server 401 described in Embodiment 1, and which is an aspect of the content managing server 401. In addition, a terminal apparatus 803 (the terminal apparatus A) illustrated in FIG. 12A to FIG. 12D is a terminal which includes the configuration of the terminal apparatus 411 described in Embodiment 1, and which is an aspect of the terminal apparatus 411. In addition, a network 801 is an aspect of the above-described network 421.

The following describes data management processing at the time of the editing operation such as trimming performed on a content item in the terminal apparatus 411, as an example of the operation described in Example 3. More specifically, the following describes an operation of the content managing server when an editing operation for generating a content item 805 is performed by trimming, in the terminal apparatus 803, a content item 804 of a content ID:7 stored in the terminal apparatus 803 (the terminal apparatus A).

First, the terminal apparatus 803 (the terminal apparatus A) performs the editing operation for generating the content item 805 by applying trimming to the content item 804 in the terminal apparatus 803 (S401).

Then, the terminal apparatus 803 detects S401 by the content and operation history transmission instructing unit 416, sends an instruction to the transmitting and receiving unit 418, and transmits content information and operation history information to the content managing server 802 (S402).

Next, the content managing server 802 newly adds, to the content managing unit 403 (the content information management region 821), the content information obtained from the terminal apparatus 803 as a content ID:7, as illustrated in FIG. 12B (S403). At this time, no information is stored into the items of the parent data and the child data (association management region) of the content ID:7 in the content managing unit 403 (the content information management region 821). The content managing server 802 notifies the terminal apparatus 803 of the new addition made to the content managing unit 403. Then, the terminal apparatus 803 is notified that the transmitted content information has been newly added to the content managing unit 403 as the content ID:7 (S404).

Next, the content managing server 802 examines whether or not a content item of the content ID:6, which is the parent data, is present in the content managing unit 403, using the operation history information received from the terminal apparatus 803. When the corresponding content item is present, operation history information (“6: trimming (50, 50, 200, 100)” in this Example) is newly added to the operation history managing unit 404 (the operation history management region 822), as illustrated in FIG. 12C (S405). It is to be noted that, when the corresponding content item is not present (not found, in S405), information is not added to the operation history managing unit 404 (the operation history management region 822), and the content management processing is terminated.

Next, since information is added to the operation history managing unit 404 (the operation history management region 822) in S405, the content managing server 802 stores information to be associated with a related content item, such as addition/modification of parent data information and child data information, in the content managing unit 403 (the association management region) (S406). In the present Example, the child data information of the content ID:6 in the content managing unit 403 (the association management region) is rewritten (stored) such that the related content ID, which is the child data, indicates “7” and the operation history ID of the operation performed to generate the child data indicates “3”. In addition, the parent data information of the content ID:7 is rewritten (stored) such that the related content ID, which is the parent data, indicates “6” and the operation history ID of the operation performed to generate the parent data indicates “3”.

As described above, the content management processing is performed which holds (processes by a characteristic procedure) a plurality of items of content related information in a characteristic data structure. This makes it possible to manage, in the content managing server 802, a content item generated by performing an editing operation such as trimming in the terminal apparatus 803 (terminal apparatus A), and to manage (use) information on a content item which is a base of the generated content item and a generation method thereof (operation history of the editing operation) (FIG. 12D).

### Example 4

### Sharing of a Content Item with a Different Terminal Apparatus

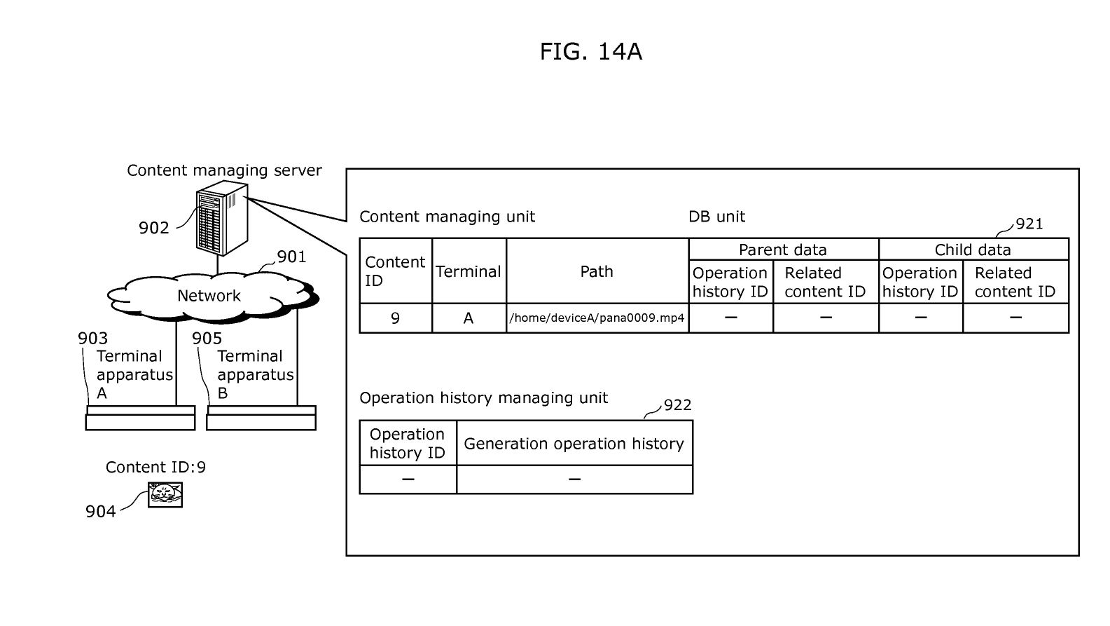

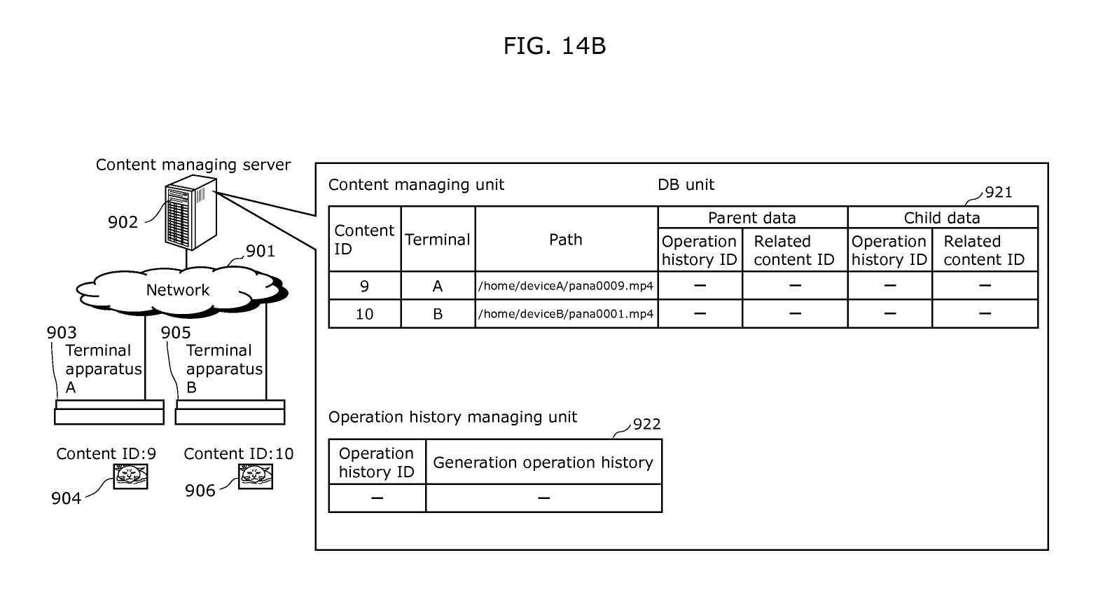

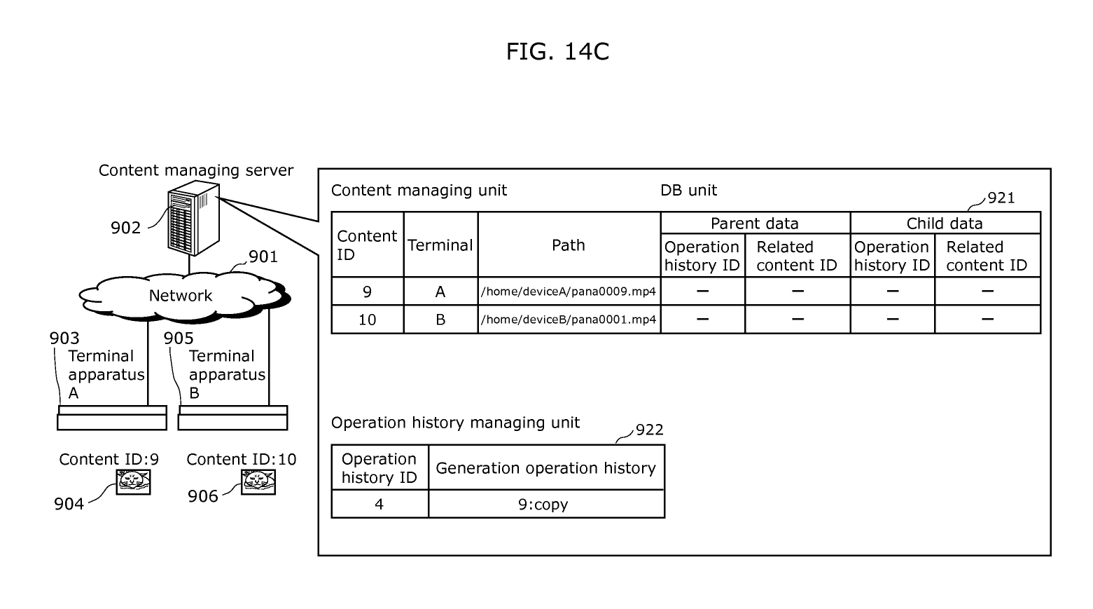

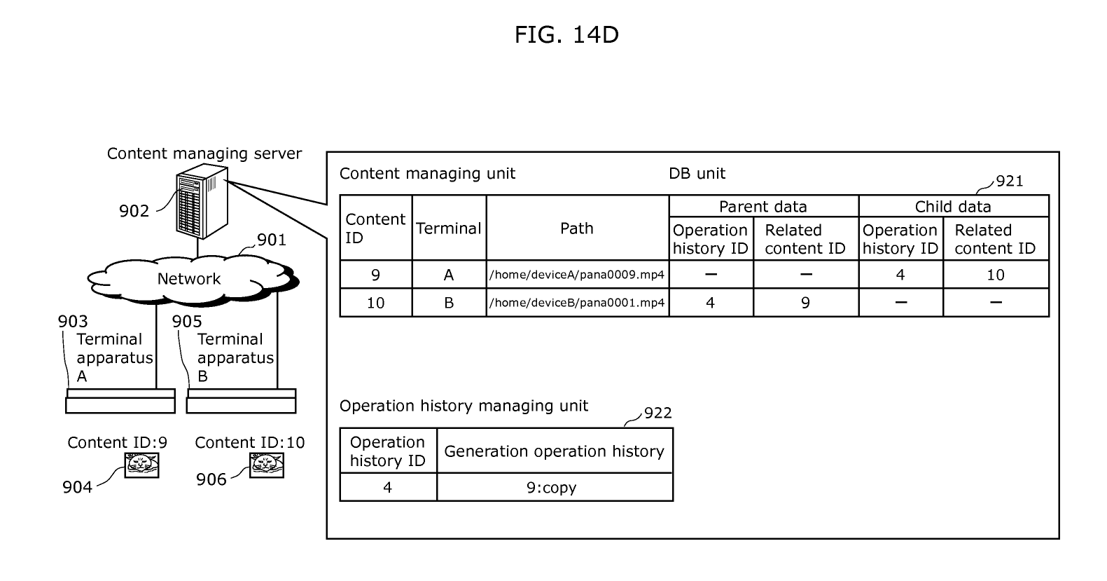

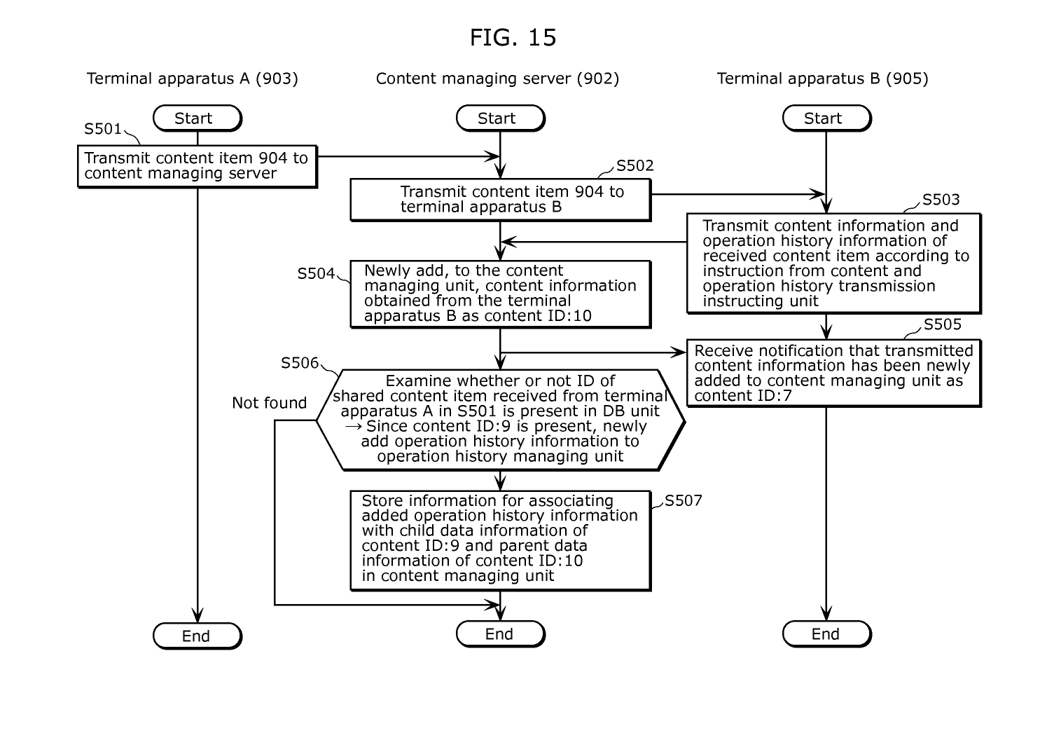

FIG. 14A to FIG. 14D are diagrams for explaining the operations of Example 4 according to Embodiment 1. FIG. 15 is a diagram illustrating the operation sequence of Example 4 according to Embodiment 1. FIG. 14A illustrates an example of a data management state prior to executing an operation of content sharing with a different terminal apparatus, which is the operation of Example 4, FIG. 14B and FIG. 14C illustrate examples of a data management state in the content managing server subsequent to executing the operation of content sharing with a different terminal apparatus. FIG. 14D illustrates an example of a data management state subsequent to data management processing.

It is to be noted that a content managing server 902 illustrated in FIG. 14A to FIG. 14D is a server which includes the configuration of the content managing server 401 described in Embodiment 1, and which is an aspect of the content managing server 401. In addition, a terminal apparatus 903 (the terminal apparatus A) and a terminal apparatus 905 (the terminal apparatus B) illustrated in FIG. 14A to FIG. 14D are each a terminal which includes the configuration of the terminal apparatus 411 described in Embodiment 1, and which is an aspect of the terminal apparatus 411. In addition, a network 901 is an aspect of the above-described network 421.

The following describes data management processing at the time of content sharing with a different terminal apparatus, as an example of the operation described in Example 4. More specifically, the following describes an operation of the content managing server when an editing operation for sharing a content item 904 of a content ID:9 stored in the terminal apparatus 903 (the terminal apparatus A) with a terminal apparatus 905 (the terminal apparatus B).

First, the terminal apparatus 903 (the terminal apparatus A) transmits the content item 904 to the content managing server so as to share the content item 904 with the terminal apparatus 905 (the terminal apparatus B) (S501). Next, the content managing server 902 receives the content item 904 from the terminal apparatus 903, and the content managing server 902, when receiving the content item 904 from the terminal apparatus 903, relays (transmits) the content item 904 to the terminal apparatus 905 (S502).

Next, the terminal apparatus 905 obtains the content item 904 from the content managing server 902. Then, the terminal apparatus 905 detects S502 by the content and operation history transmission instructing unit 416, sends an instruction to the transmitting and receiving unit 418, and transmits content information and operation history information to the content managing server 902 (S503). The operation history information indicates the editing operations in which a replication of the content item 904 is received and a content item 906 is generated.

Next, the content managing server 902 newly adds, to the content managing unit 403, the content information obtained from the terminal apparatus 905, as a content ID:10, as illustrated in FIG. 14B (S504). At this time, unlike the case of Example 1 of the Embodiment, the content information is transmitted from the terminal apparatus 905, and thus the information in the content managing unit 403 (the content information management region 921), which indicates the terminal holding the corresponding content item is “B”. The content managing server 902 notifies the terminal apparatus 905 of the new addition made to the content managing unit 403. Then, the terminal apparatus 905 is notified that the transmitted content information has been newly added to the content managing unit 403 as the content ID:10 (S505).

Next, the content managing server 902 examines whether or not an ID of the shared content item received from the terminal apparatus 903 in S501 is present in the content managing unit 403. When the corresponding content item is present in the content managing unit 403, operation history information (“9: copy” in this Example) is newly added to the operation history managing unit 404 (the operation history management region 922), as illustrated in FIG. 14C (S506). It is to be noted that, when the corresponding content item is not present (not found, in S506), information is not added to the operation history managing unit 404 (the operation history management region 922), and the content management processing is terminated.

Next, since information is added to the operation history managing unit 404 (the operation history management region 922) in S506, the content managing server 902 stores information to be associated with a related content item, such as addition/modification of parent data information and child data information, in the content managing unit 403 (the association management region) (S507). In the present Example, the child data information of the content ID:9 in the content managing unit 403 (the association management region) is rewritten such that the related content ID, which is the child data, indicates “10” and the operation history ID of the operation performed to generate the child data indicates “4”. In addition, the parent data information of the content ID:10 is rewritten such that the related content ID, which is the parent data, indicates “9” and the operation history ID of the operation performed to generate the parent data indicates “4”.

As described above, the content management processing is performed which holds (processes by a characteristic procedure) a plurality of items of content related information in a characteristic data structure. This makes it possible not only to manage, in the content managing server 902, a content item 906 shared with the terminal apparatus 905 (the terminal apparatus B) by the terminal apparatus 903 (the terminal apparatus A), but also to manage (use) information on a content item which is a base of the shared content item and a method by which the shared content item is generated (FIG. 14D).

### Example 5

### Content Deletion

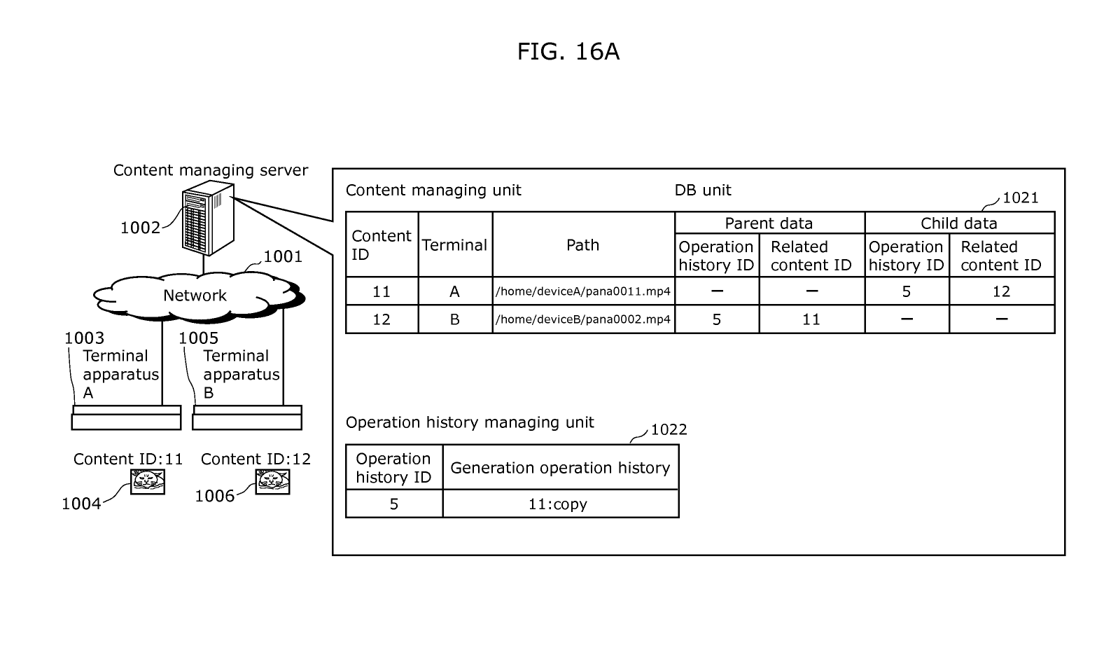

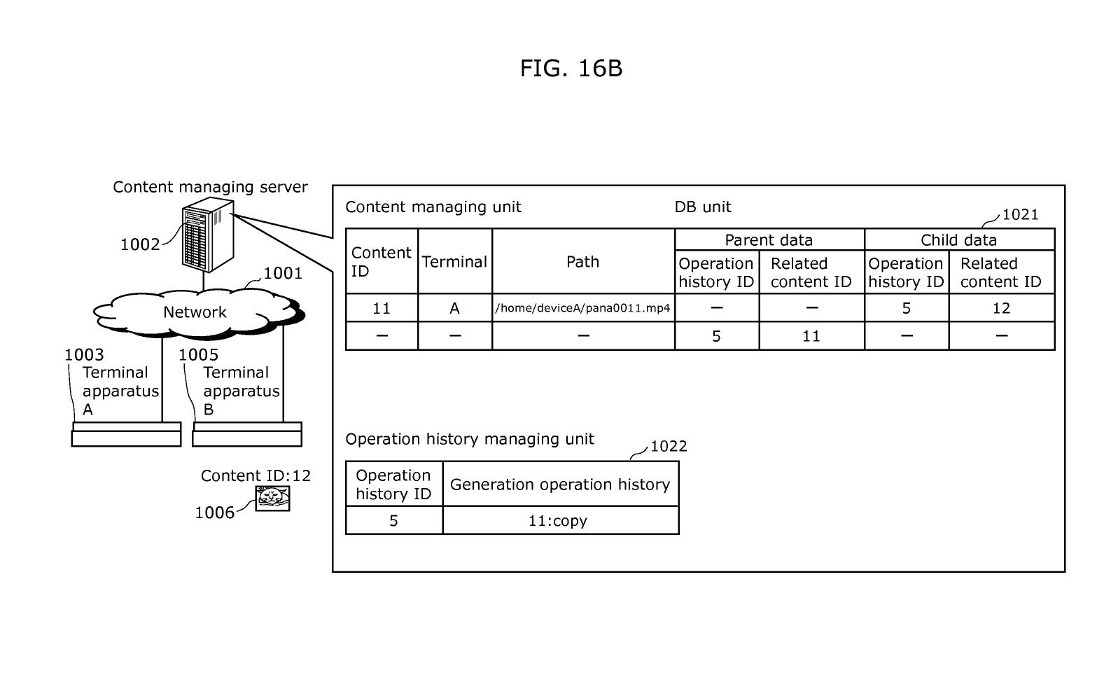

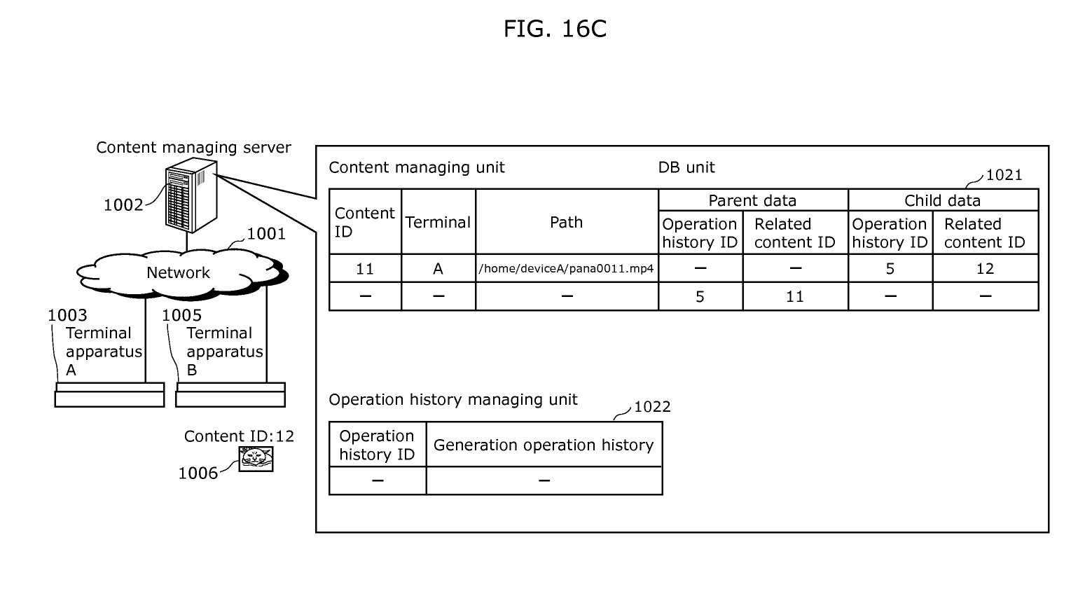

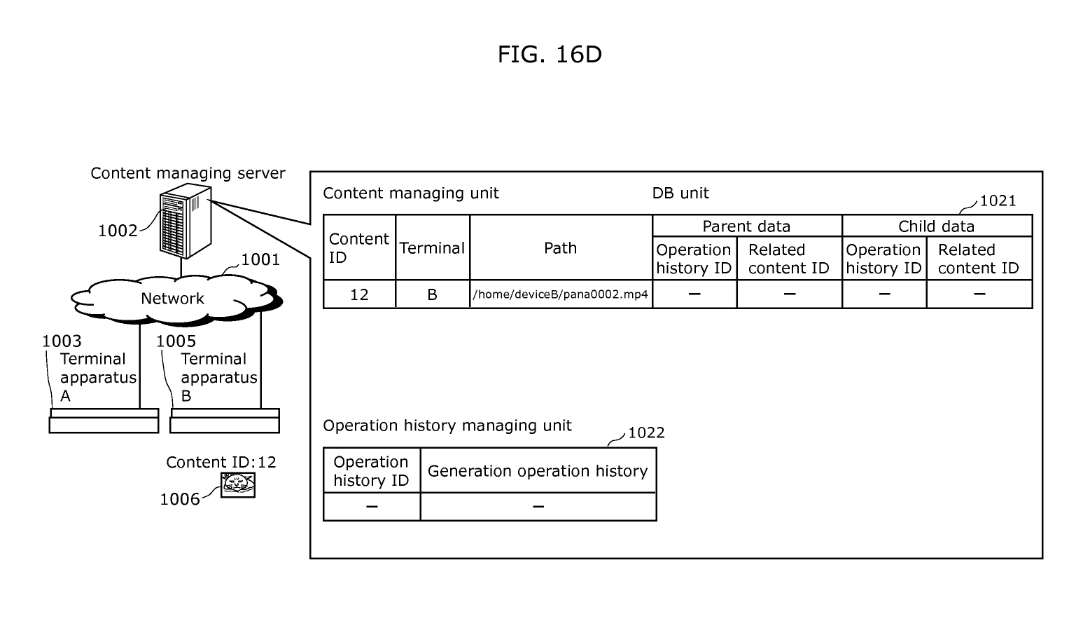

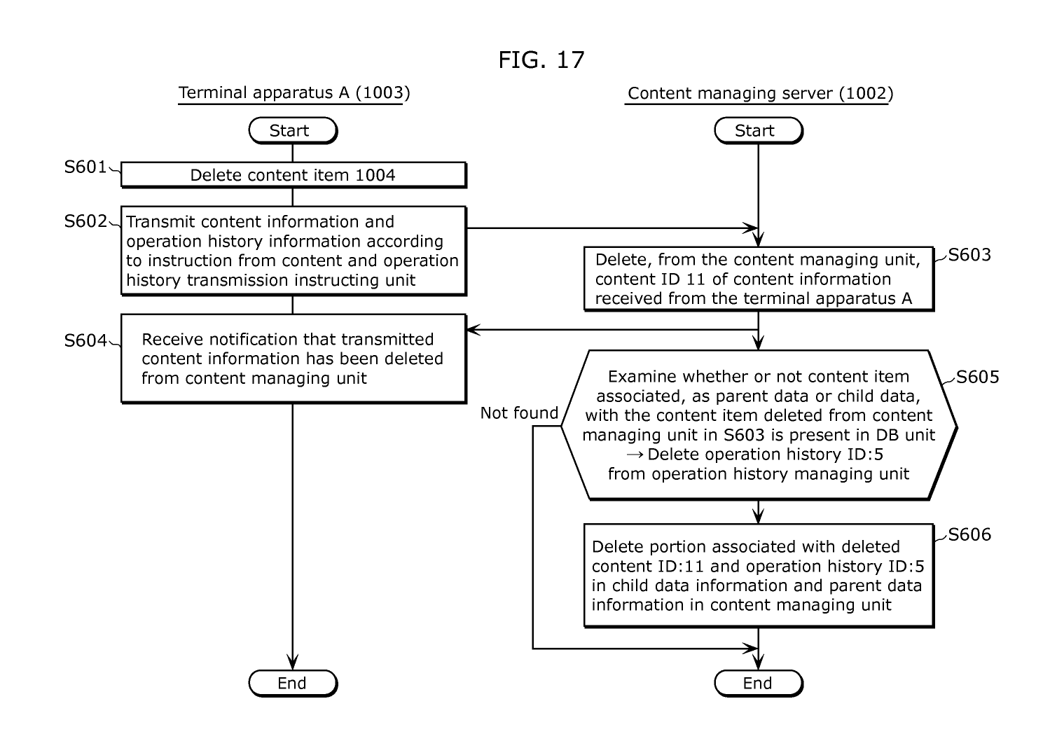

FIG. 16A to FIG. 16D are diagrams for explaining the operations of Example 5 according to Embodiment 1. FIG. 17 is a diagram illustrating the operation sequence of Example 5 according to Embodiment 1. FIG. 16A illustrates an example of a data management state prior to executing the operation of content deletion which is the operation of Example 5. FIG. 16B and FIG. 16C illustrate examples of a data management state in the content managing server subsequent to executing the operation of content deletion. FIG. 16D illustrates an example of a data management state subsequent to data management processing.

It is to be noted that a content managing server 1002 illustrated in FIG. 16A to FIG. 16D is a server which includes the configuration of the content managing server 401 described in Embodiment 1, and which is an aspect of the content managing server 401. In addition, a terminal apparatus 1003 (the terminal apparatus A) and a terminal apparatus 1005 (the terminal apparatus B) illustrated in FIG. 16A to FIG. 16D are each a terminal which includes the configuration of the terminal apparatus 411 described in Embodiment 1, and which is an aspect of the terminal apparatus 411. In addition, a network 1001 is an aspect of the above-described network 421.

The following describes data management processing at the time of content deletion as an example of the operation described in Example 5. Specifically, the following description assumes the state where a content item 1004 of a content ID:11 stored in the terminal apparatus 1003 (the terminal apparatus A) is shared in advance with the terminal apparatus 905 (the terminal apparatus B). The following describes the operations of the content managing server, when the editing operation of deleting the content item 1004 of the content ID:11 stored in the terminal apparatus 1003 is performed.

First, it is assumed that the content item 1004 of the content ID:11 stored in the terminal apparatus 1003 is shared in advance with the terminal apparatus 1005, and is managed also by the content managing server 1002 (FIG. 16A).

Next, the terminal apparatus 1003 deletes the content item 1004 (S601).

Then, the terminal apparatus 1003 detects S601 by the content and operation history transmission instructing unit 416, sends a command (instruction) to the transmitting and receiving unit 418, and transmits content information and operation history information (information indicating “deletion” in this case) to the content managing server 1002 (S602).

Next, the content managing server 1002 deletes the content ID:11 of the corresponding content item from the content managing unit 403 (the content information management region 1021), according to the content information received from the terminal apparatus 1003, as illustrated in FIG. 16B (S603). The content managing server 1002 notifies the terminal apparatus 1003 of the deletion from the content managing unit 403. Then, the terminal apparatus 1003 is notified that the content ID:11 corresponding to the transmitted content information has been deleted from the content managing unit 403 (S604).

Next, the content managing server 1002 examines whether or not a content item associated, as the parent data or the child data (parent-child relationship), with the content item deleted from the content managing unit 403 (the content information management region 1021) in S603 is present in the operation history managing unit 404 (the operation history management region 1022). When the corresponding content item is present in the operation history managing unit 404, corresponding operation history information is deleted (S605). In this Example, the operation history ID:5 is deleted. It is to be noted that, when the corresponding content item is not present (not found, in S605), editing (deletion) is not performed on the operation history managing unit 404 (the operation history management region 1022), and the content management processing is terminated.

Next, since the corresponding operation history information is deleted from the operation history managing unit 404 (the operation history management region 1022) in S605, the content managing server 1002 deletes information in which the content item deleted by adding or modifying the parent data information and the child data information is associated with the related content item, in the content managing unit 403 (the association management region) (S605). In this Example, the content ID 12 is associated with the content ID:11 of the deleted content item, and thus the association is deleted.

As described above, the content management processing is performed which holds (processes by a characteristic procedure) a plurality of items of content related information in a characteristic data structure. This makes it possible to manage, in the content managing server 1002, a content item obtained by performing, on the content item 1006 of the terminal apparatus 1003 (the terminal apparatus A) which is sheared with the terminal apparatus 1005 (the terminal apparatus B). This means that it is possible to properly maintain the DB unit 402 of the content managing server 1002 even when the content item 1006 is deleted in the state that the content item 1006 is associated in the content managing server 1002.

It is to be noted that S603 to S606 need not necessarily be executed in consideration of the probability that a usage method for restoring the content item shared with the different terminal apparatus is required.

According to the present embodiment described above, content information can be properly migrated even when the content item is a content item obtained by an editing operation by a terminal apparatus, allowing for proper management by the content managing server. In addition, the association with the original content item which is the base can also be clearly managed by the operation history in the content managing server. Thus, it is possible to implement a content managing apparatus capable of properly managing a relationship between a large number of content items.

More specifically, the content managing apparatus according to the present embodiment (i) holds relationship information between content data items, in a content management region, (ii) holds operation history information indicating a relationship of editing operation between the content data items, in an operation history management region, and (iii) holds a relationship of a content item and an editing operation, in an association management region. This makes it possible to obtain information on a base content item and properly manage the information even when a content item is newly generated by combining a plurality of content items, trimming part of the content item, and the like.

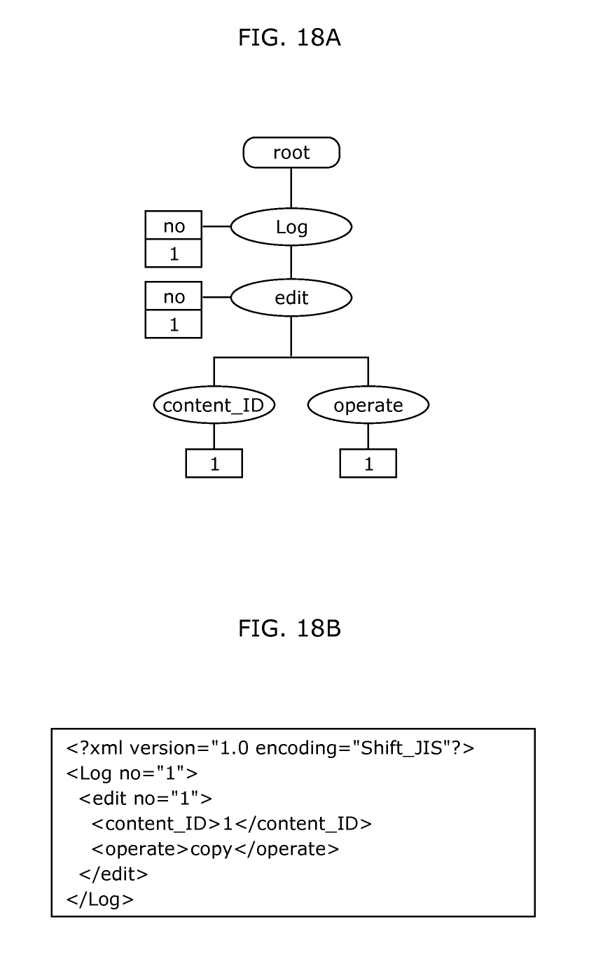

It is to be noted that, although the DB unit 402 is described as a relational database (RDB) format, the format of managing (storing) information is not limited to the RDB. For example, the format may be an extensible markup language (XML) format or the like as illustrated in FIG. 18A and FIG. 18B. Here, FIG. 18A and FIG. 18B are diagrams indicating description examples of the operation history according to the present embodiment, and indicating the XML format.

In addition, although the ID of a content item held by the terminal apparatus such as the first communication apparatus and the second communication apparatus, for example, and the ID which is an example of content information of corresponding content item managed by the content managing server are explained as being the same number for simplifying the description in the above-described Examples, the ID is not limited thereto. Different IDs may be used for management as long as the content managing server can associate the IDs with the content items held by the terminal apparatus.

### Embodiment 2

In Embodiment 2, an example of a usage method for using a data management state in the content managing server according to Embodiment 1 (a characteristic data structure in which related information items of a plurality of content items are held) will be described. More specifically, a method will be described by which content data is restored when a content item (the content data) stored in a terminal apparatus is lost.

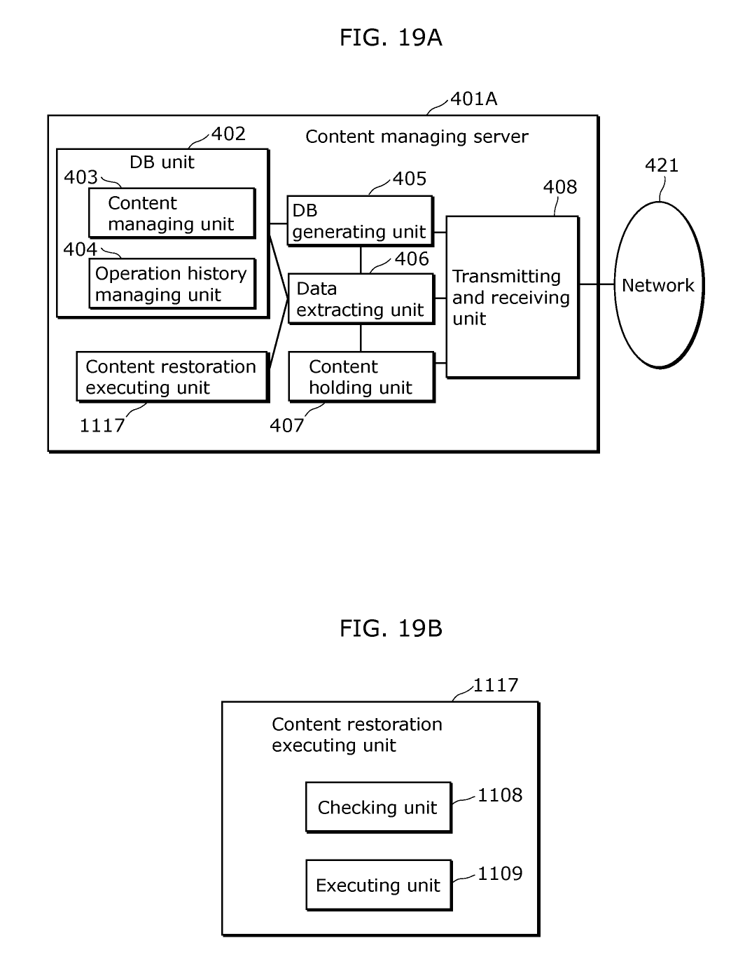

First, a configuration of a content managing server 401A according to Embodiment 2 is described, with reference to FIG. 19A and FIG. 19B.

FIG. 19A is a block diagram illustrating an example of a configuration of the content managing server according to Embodiment 2. FIG. 19B is a block diagram illustrating an example of a detailed configuration of a content restoration executing unit 1117 according to Embodiment 2. It is to be noted that elements equivalent to those in FIG. 5A share the same reference numerals and detailed explanation thereof will be omitted. In addition, the configurations are each implemented using a hardware configuration such as the above-described CPU, the memory, and the communication device.

The content managing server 401A illustrated in FIG. 19A has a configuration different from the configuration of the content managing server 401 according to Embodiment 1, in that the content restoration executing unit 1117 is added.

The content restoration executing unit 1117, when a restoration request for restoring the first content item which the different terminal apparatus 411A has lost is transmitted from the different terminal apparatus 411A, executes restoration of the first content item using information items held in the content managing unit 403 and the operation history managing unit 404.

More specifically, the content restoration executing unit 1117 includes a checking unit 1108 and an executing unit 1109.

The checking unit 1108 performs checking by searching the content managing unit 403 and the operation history managing unit 404 which include the association management region in which the second content information identified based on the first content information and the second operation history information including the second content information are present.

When the checking unit 1108 confirms that the second content information and the second operation history information are present, the executing unit 1109 transmits the second content item according to the second operation history information, to the different terminal apparatus 411A indicated by third content information, thereby restoring the first content item of the different terminal apparatus 411A.

Next, a configuration of the terminal apparatus 411A according to Embodiment 2 will be described in detail.

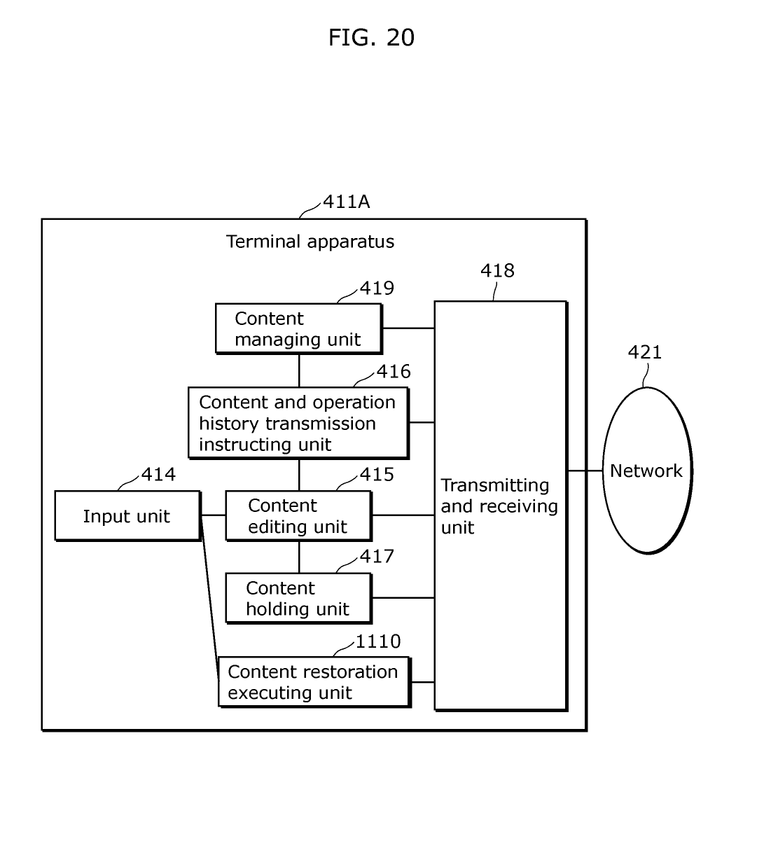

FIG. 20 is a block diagram illustrating an example of the configuration of the terminal apparatus 411A according to Embodiment 2. It is to be noted that elements equivalent to those in FIG. 6 share the same reference numerals and detailed explanation thereof will be omitted. In addition, the configurations illustrated in FIG. 20A are each implemented using a hardware configuration such as the above-described CPU, the memory, and the communication device.

The terminal apparatus 411A illustrated in FIG. 20 has a configuration different from the configuration of the content terminal apparatus 411 according to Embodiment 1, in that the content restoration requesting unit 111 is added.

The content restoration requesting unit 420, when a content item in the terminal apparatus 411A is lost, for example, transmits a content restoration request via the transmitting and receiving unit 418 to the network 421. The content restoration requesting unit 420 transmits the content restoration request toward the content managing server 401A.

It is to be noted that, according to this embodiment, the content restoration requesting unit 1110 is connected to the input unit 414 and executes the content restoration request in response to an operation by a user, however, the execution of the content restoration request is not limited to this. Corruption of content may be automatically detected in the terminal apparatus 411A, and the content restoration request may be executed without an operation by a user when corruption of content is detected.

The following describes operations of the above-described content managing server 401A and the terminal apparatus 411A.

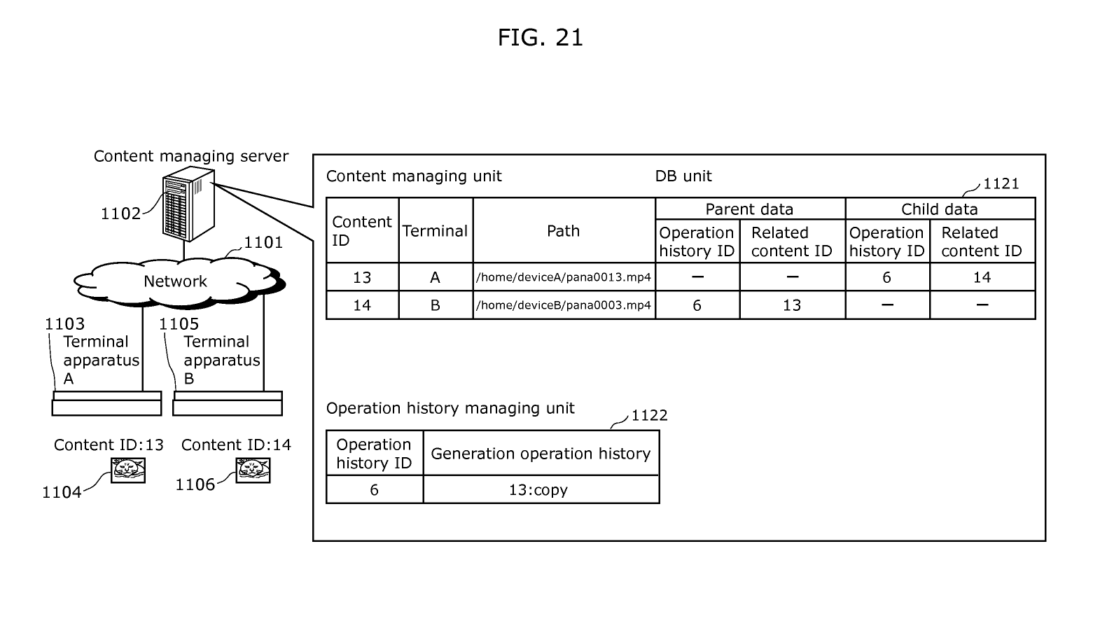

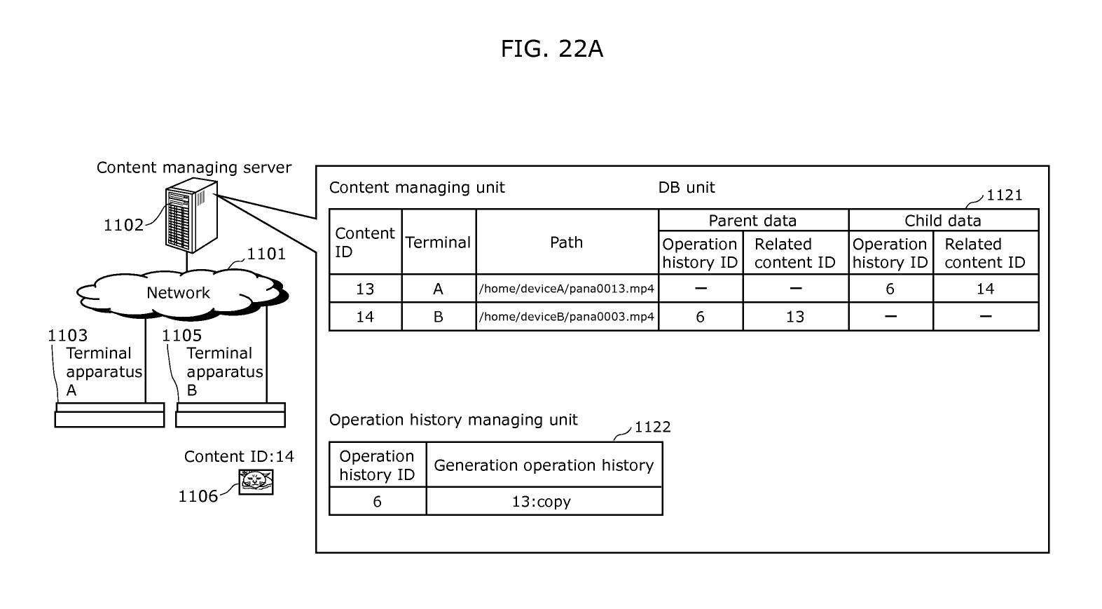

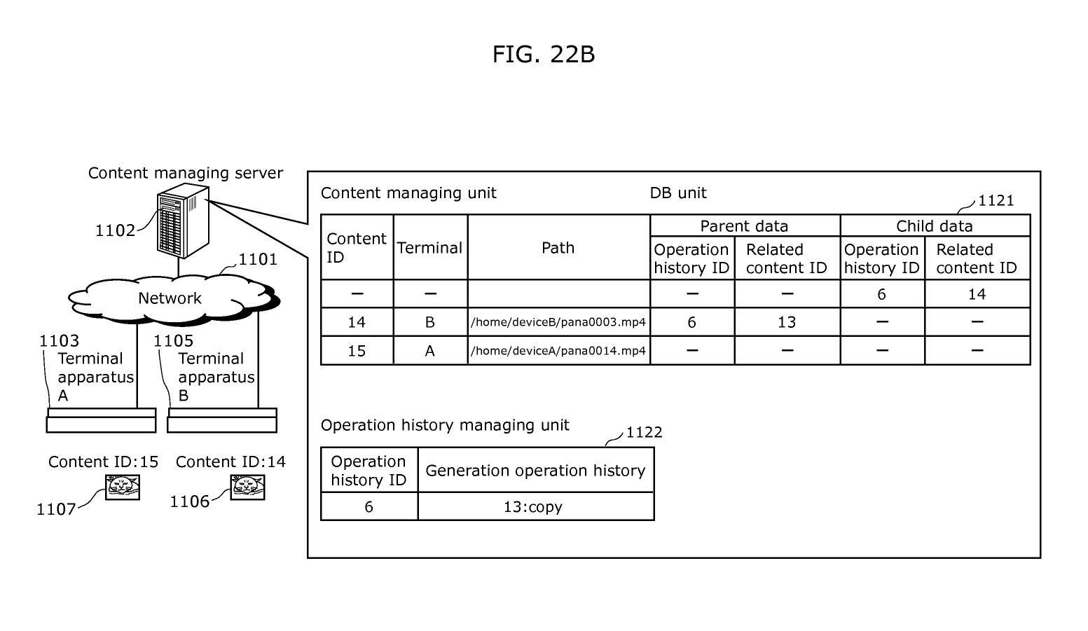

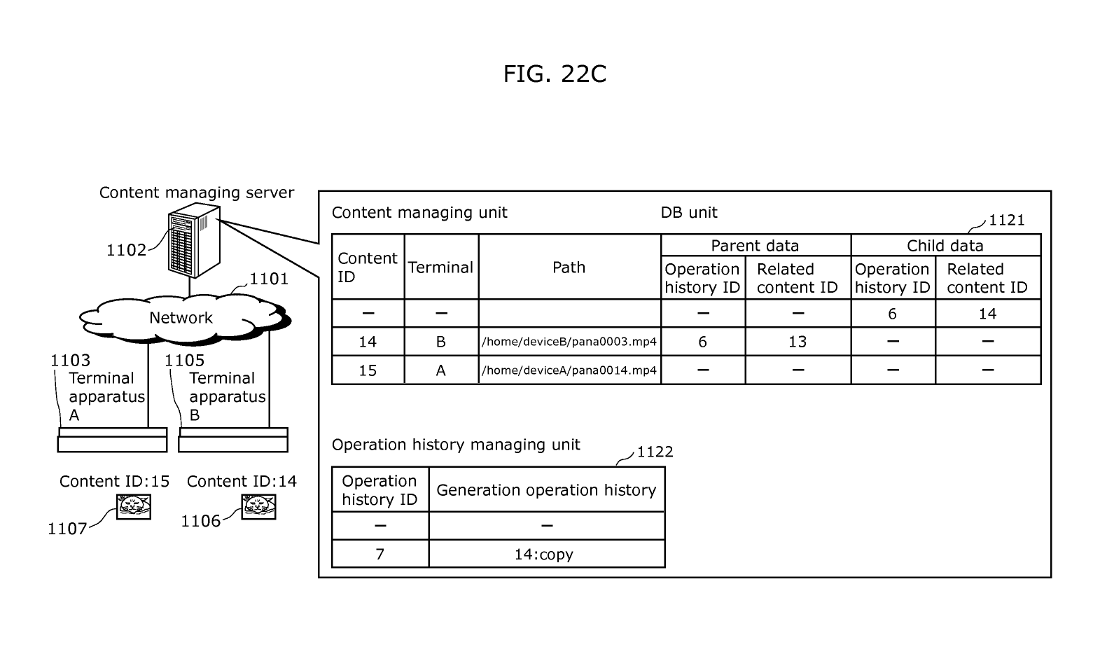

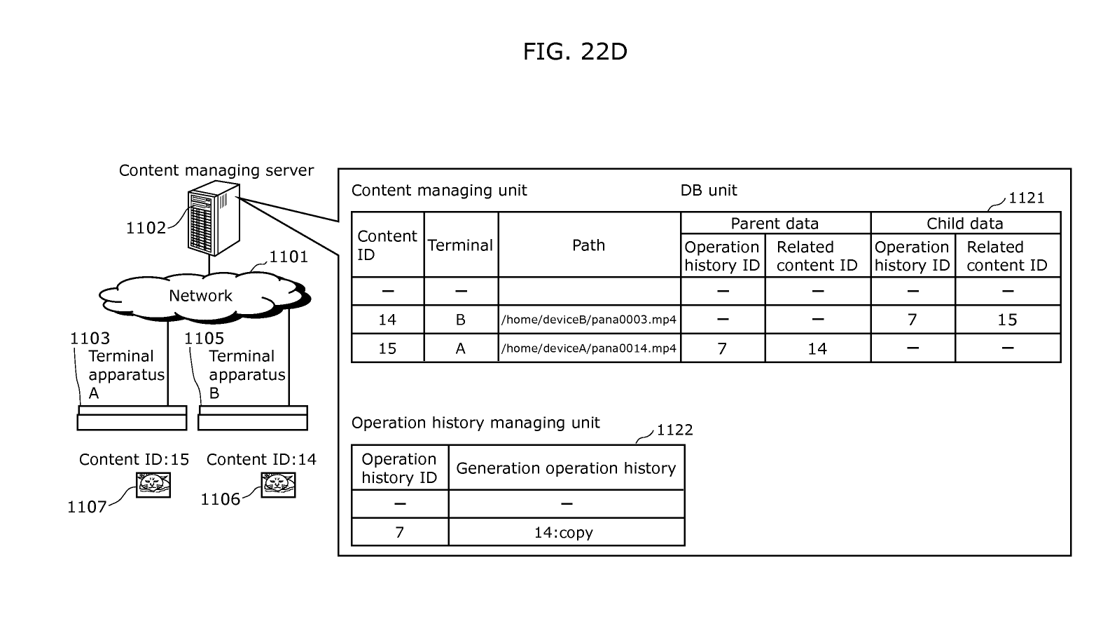

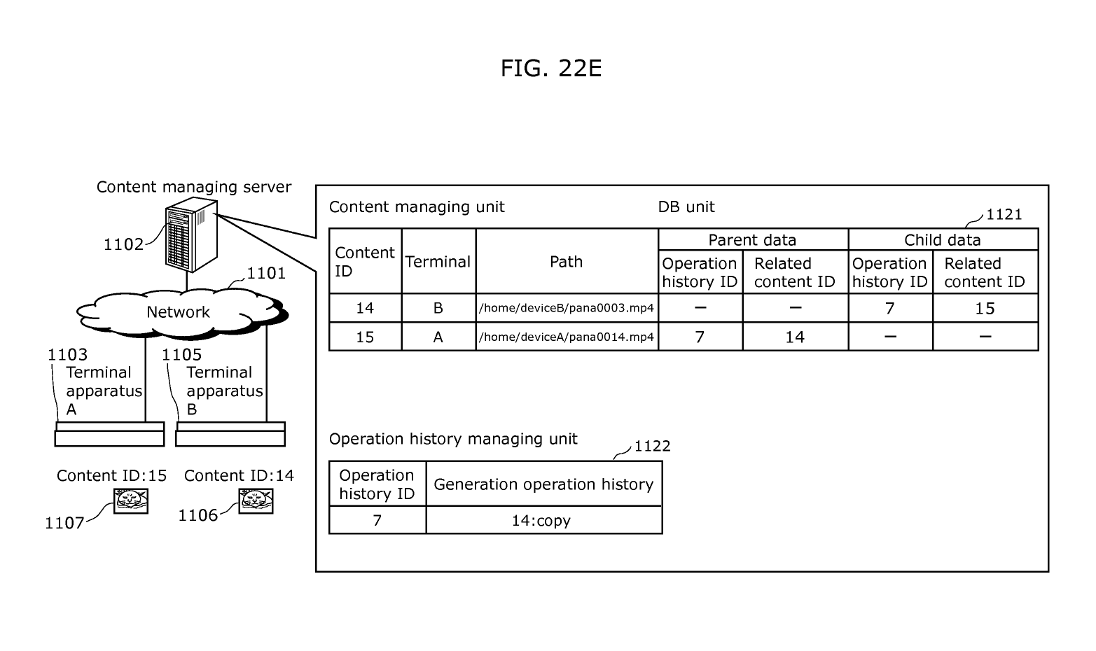

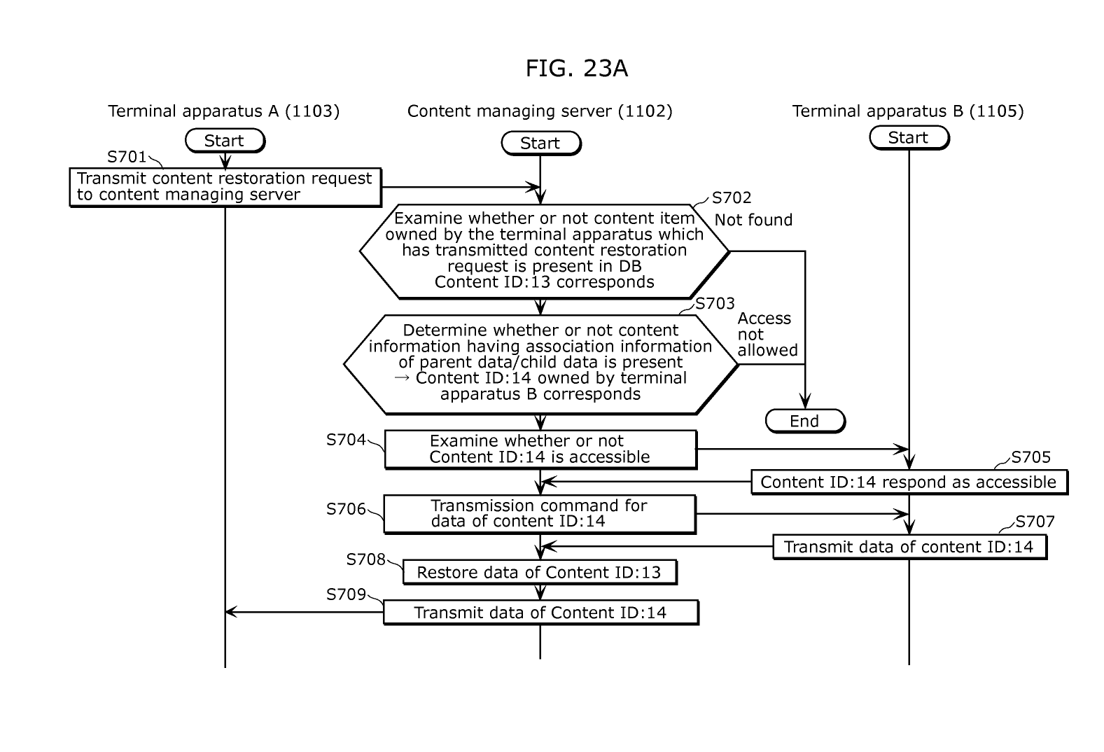

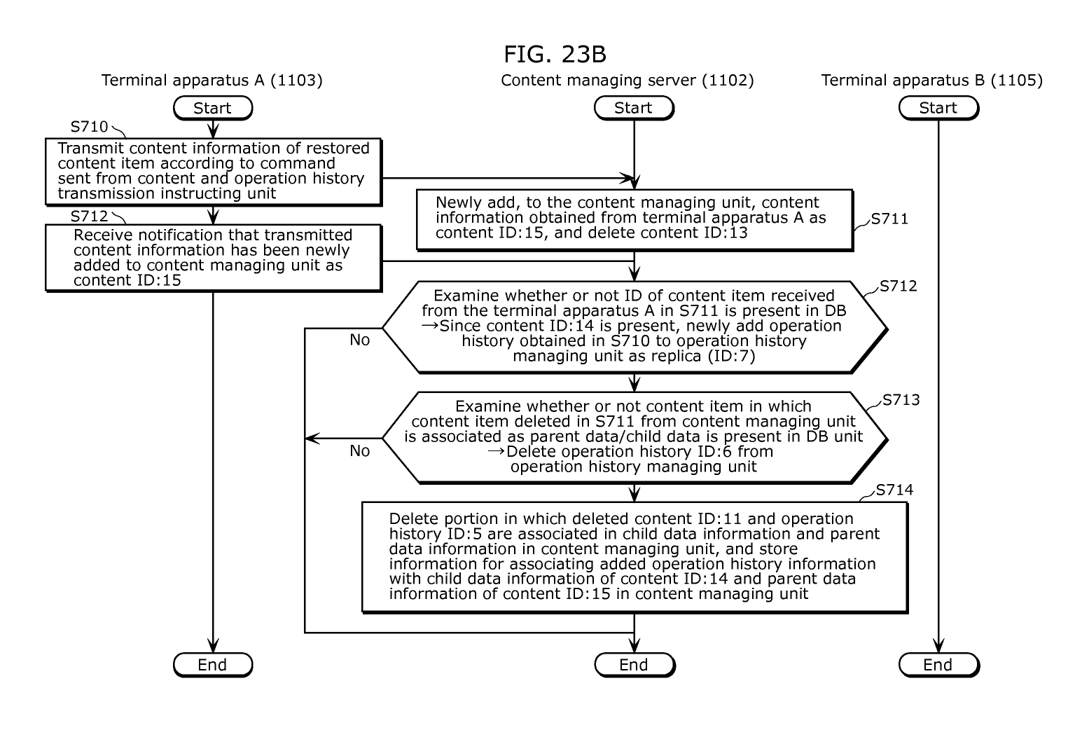

FIG. 21, and FIG. 22A to FIG. 22E are diagrams for explaining the operations according to Embodiment 2, FIG. 23A and FIG. 23B are diagram each of which illustrates an operation sequence according to Embodiment 2. FIG. 21 and FIG. 22A each illustrate an example of a data management state prior to executing content restoration which is the operation according to this embodiment. FIG. 22A to FIG. 22D illustrate examples of a data management state in the content managing server during the operation of content restoration. FIG. 22ED illustrates an example of a data management state subsequent to the operation of content restoration.

It is to be noted that a content managing server 1102 illustrated in FIG. 21, and FIG. 22A to FIG. 22E is a server which includes the configuration of the content managing server 401A, and which is an aspect of the content managing server 401A. In addition, a terminal apparatus 1103 (the terminal apparatus A) and a terminal apparatus 1105 (the terminal apparatus B) illustrated in FIG. 21, and FIG. 22A to FIG. 22E are each a terminal which includes the configuration of the terminal apparatus 411A, and which is an aspect of the terminal apparatus 411A. In addition, a network 1101 is an aspect of the above-described network 421.

The following describes data management processing performed at the time when a lost content item of the terminal apparatus 411A is restored, as an operation example of this embodiment.

First, a content item 1104 in the terminal apparatus 1103 (the terminal apparatus A) is shared with the terminal apparatus 1105 (the terminal apparatus B), as illustrated in FIG. 21. It is assumed that the content item 1104 which is present in the terminal apparatus 1103 is lost as illustrated in FIG. 22A.

In this case, the content restoration requesting unit 1110 of the terminal apparatus 1103, first, transmits the content restoration request provided by an operation of a user (from the input unit 414) to the content managing server 1102 (S701).

Next, the content managing server 1102, when receiving the content restoration request from the terminal apparatus 1103, examines whether or not the content item owned by the terminal apparatus 1103 which has transmitted the content restoration request is present (stored) in the content managing unit 403 (S702). Here, in this embodiment, whether or not a content ID:13 is stored is examined.

Next, when the corresponding data item (content ID:13) is present, it is determined whether or not the corresponding data item has information (association information) related as parent data or child data (parent-child relationship) in the content managing unit 403 (S703). According to this embodiment, content information having information associated with a content ID:14 of the terminal apparatus 1105 is the corresponding data item. It is to be noted that, when there are a plurality of related information items (association information) of parent data/child data of a restoration target content item, one related information item is selected out of the related information items. Criteria for the selection are not defined.

Next, a confirmation packet is transmitted to the terminal apparatus 1105 in order to examine whether or not the related information (association information) of the parent data/child data is accessible (S704). It is to be noted that, when the content managing server 1102 holds an access permission list or the like between terminal apparatuses or between users, a step of determining the presence or absence of an access may be performed with reference to the list.

Next, the terminal apparatus 1105 receives the confirmation packet for the content item which is the target for restoration of a content item, and transmits a response to the content managing server 1102 when the corresponding content item is accessible (S705).

Next, the content managing server 1102, when receiving the response indicating that the corresponding content item is accessible, transmits, to the content managing server 1102, a transmission command so that the corresponding content item is transmitted (S706). Here, a transmission command for transmitting content data of the content ID:14 is transmitted.

Next, the terminal apparatus 1105 transmits the content data of the content ID:14 to the content managing server 1102, according to the above-described transmission command (S707).

Next, the content managing server 1102, when receiving the content data of the content ID:14, executes restoration of the content item of the terminal apparatus 1103 (S708). More specifically, the content restoration executing unit 1117 executes the restoration process using the obtained content item, with reference to the operation history information associated with the corresponding content item. According to this embodiment, the information (association information) related to the content ID:14 held in the content managing unit 403 (the content information management region 1121) is an operation history ID:6. Here, the operation history ID:6 is a copy of the content ID:13, and therefore an additional process (restoration process) is not performed.

Next, the content managing server 1102 transmits the content item on which the restoration process has been performed, to the terminal apparatus 103 (S709).

Then, the terminal apparatus 1103 which requested the content restoration, when receiving the content item which is the target for content restoration, stores the received content item into the content managing unit 419 and the content holding unit 417 in the terminal apparatus 1103. Restoration of a content item can be implemented as described above.

It is to be noted that, the content managing server 1102 updates the DB unit 402 subsequent to S709. Specific processes thereof are as described in Example 1 and Example 5 according to Embodiment 1.

More specifically, the terminal apparatus 1103, first, detects the content restoration operation (S709) using the content and operation history transmission instructing unit 416, sends an instruction to the transmitting and receiving unit 418, and transmits the content information and the operation history information to the content managing server 1102 (S710).

Next, the content managing server 1102 newly adds, to the content managing unit 403, the content information obtained from the terminal apparatus 1103 as a content ID:15, as illustrated in FIG. 22B (S711). At this time, no information is stored into the items of parent data and child data (association management region) of the content ID:5 in the content managing unit 403 (the content information management region 1121). In addition, the content information before the restoration is deleted.

The content managing server 1102 notifies the terminal apparatus 1003 accordingly. Then, the terminal apparatus 1103 is notified that the transmitted content information has been newly added to the content managing unit 403 as the content ID:15 (S712).

Next, the content managing server 1102 examines whether or not a content item which is the parent data is present in the content managing unit 403, using the above-described operation history information received from the terminal apparatus 1103. When the corresponding content item is present, operation history information (“14: copy” in this case) is newly added to the operation history managing unit 404 (the operation history management region 1122), as illustrated in FIG. 22C (S712). It is to be noted that, when the corresponding content item is not present (not available, in S712), information is not added to the operation history managing unit 404 (the operation history management region 1122), and the content management processing is terminated.

Next, the content managing server 1102 examines whether or not a content item associated, as the parent data or the child data (parent-child relationship), with the content item deleted from the content managing unit 403 (the content information management region 1121) in S711 is present in the operation history managing unit 404 (the operation history management region 1122). When the corresponding content item is present in the operation history managing unit 404, corresponding operation history information is deleted (S713).

According to this embodiment, the restored content item is stored in the content managing unit 403 as the content ID:15, and the content ID:13 and the operation history ID:6 are deleted from the content managing unit 403 and the operation history managing unit 404.

Next, as illustrated in FIG. 22D, the content managing server 1102 deletes information in which the deleted content item is associated with the related content item, in the content managing unit 403 (the association management region), and stores information for associating the added content item and the related content item. According to this embodiment, further in the content managing unit 403, the content ID:14 and the content ID:15 receives modification on the parent data/child data, and are associated with the operation history information (association information is stored). In addition, the related information of the portion related to the content ID:13 and the operation history ID:6 is deleted from the content managing unit 403 and the operation history managing unit 404.

Through the restoration operation and the content management processing carried out as descry above, when there is a content item shared with a different terminal apparatus, it is possible to restore a content item by sending a content restoration request to the content managing server, even when the content item is lost in the terminal apparatus (FIG. 22E).

### Embodiment 3

In Embodiment 3, another example of a usage method for using a data management state in the content managing server according to Embodiment 1 (a characteristic data structure in which related information items of a plurality of content items are held) will be described. More specifically, a method will be described by which content data is restored when a content item (the content data) stored in a terminal apparatus has been lost. Embodiment 3 differs from Embodiment 2 in that: a reduced image of a content item corresponding to content information stored in the DB unit of the content managing server is held; and a similar content item is restored by restoring the content time from the reduced image although the quality is lower than a quality of the original.

In other words, the configurations of the content managing server and the terminal apparatus according to Embodiment 3 are equivalent to the configurations according to Embodiment 2. However, they differ in that, in the content managing server, a reduced image of a content item corresponding to content information stored in the DB unit 402 is held in the content holding unit 407, and information (the content information and the operation history information) on the reduced image are stored in the DB unit 402.

The following describes operations performed when the content managing server 401A generates a reduced image of a content item.

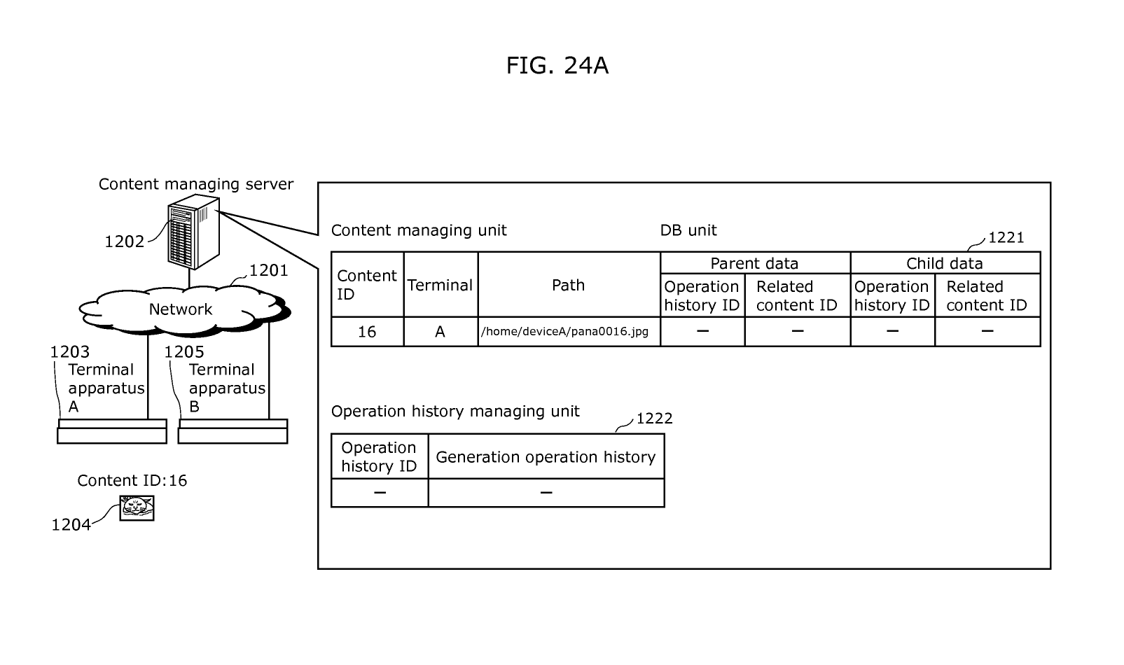

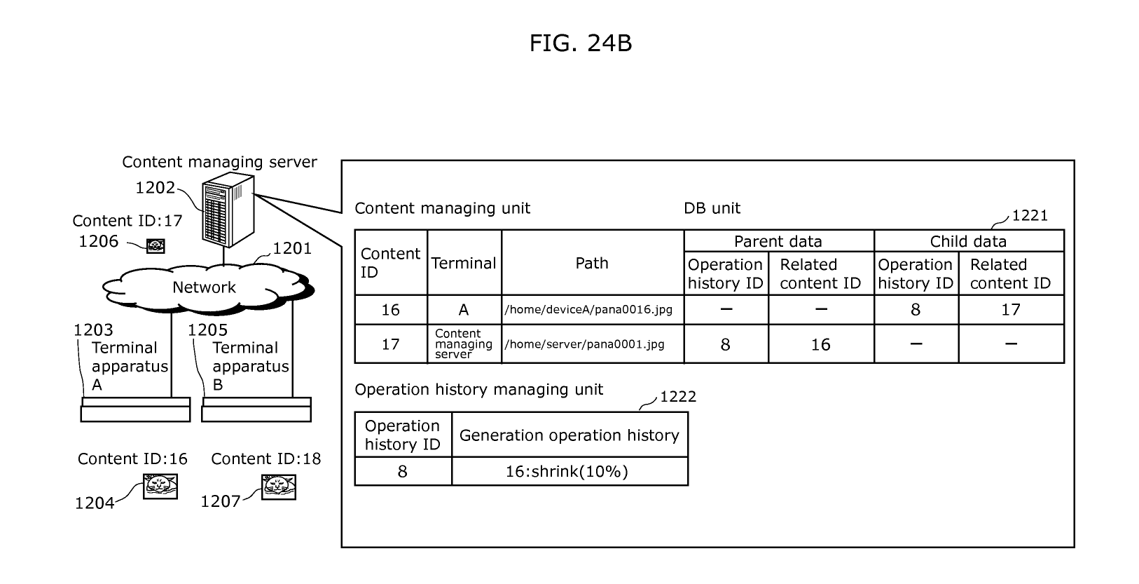

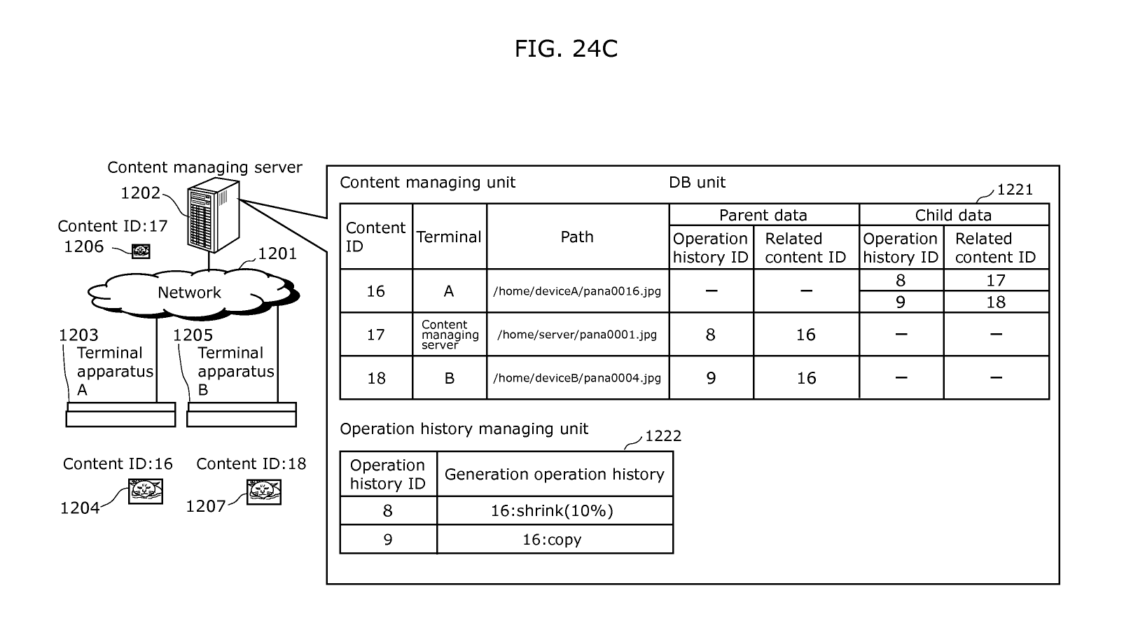

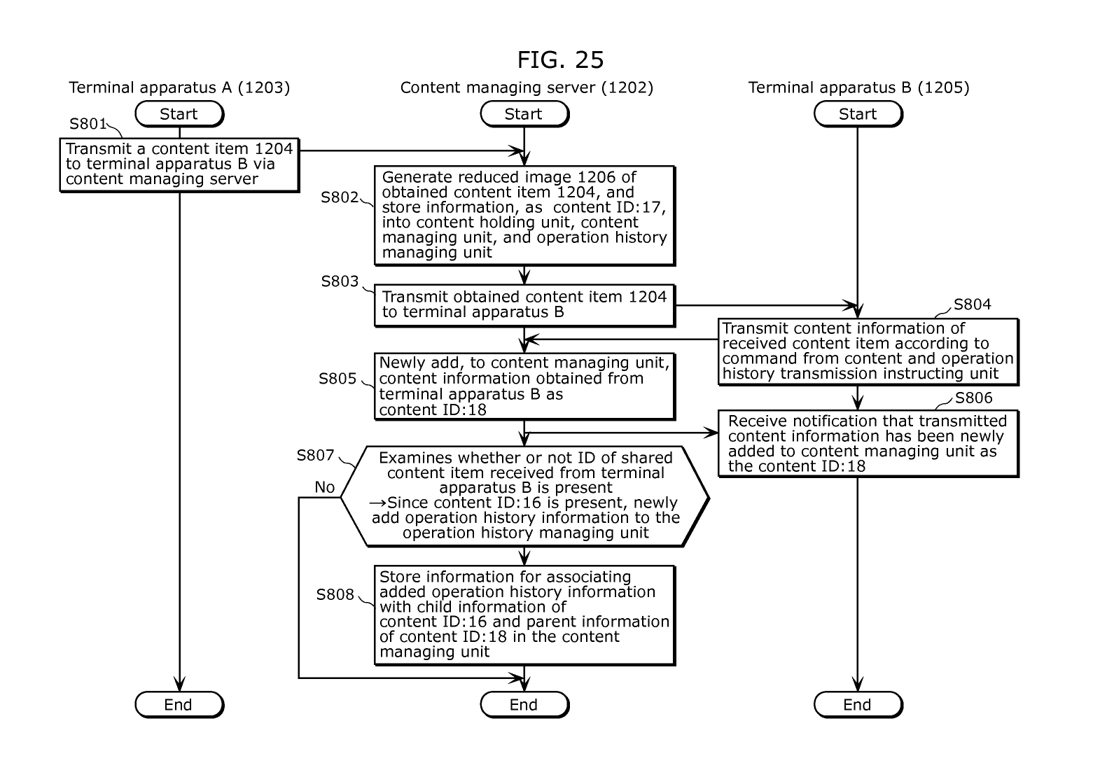

FIG. 24A to FIG. 24C are diagrams for explaining the operations performed when generating a reduced image according to Embodiment 3, FIG. 25 is a diagram illustrating an operation sequence for generating a reduced image according to Embodiment 3, FIG. 24A illustrates an example of a data management state prior to executing the operation of generating a reduced image. FIG. 24B illustrates an example of a data management state when a reduced image is generated. FIG. 24C illustrates an example of a data management state subsequent to data management processing.

It is to be noted that a content managing server 1202 illustrated in FIG. 24A to FIG. 24C is a server which includes the configuration of the content managing server 401A, and which is an aspect of the content managing server 401A. In addition, a terminal apparatus 1203 (the terminal apparatus A) and a terminal apparatus 1205 (the terminal apparatus B) illustrated in FIG. 24A to FIG. 24C are each a terminal which includes the configuration of the terminal apparatus 411A, and which is an aspect of the terminal apparatus 411A. In addition, a network 1201 is an aspect of the above-described network 421.

The following describes data management processing performed by the content managing server 401A when explaining the operation for generating a reduced image. It is to be noted that, since specific processes are equivalent to those as described in Example 4 of Embodiment 1, only the outline will be explained.

The terminal apparatus 1203 transmits a content item 1204 to the terminal apparatus 1205 via the content managing server, for sharing the content item 1204 with the terminal apparatus 1205 (S801).

Next, the content managing server 1202, when receiving (obtaining) the content item from the terminal apparatus 1203, generates a reduced image of the obtained content item, and stores information, as a new content item 1206, into the content holding unit 407, the content managing unit 403, and the operation history managing unit 404 in the content managing server 1202 (S802). According to this embodiment, the content item 1206 is registered on the content managing unit as a content ID: 17, and information such as “16: shrink (10%)” is stored in the operation history managing unit.

Subsequent to S802, the content managing server 1202 relays the content item 1204 to the terminal apparatus 1205 (S803).

Next, the terminal apparatus 1205 obtains the content item 1204 from the content managing server. Then, the content and operation history transmission instructing unit 416 detects S803, sends an instruction to the transmitting and receiving unit 418, and transmits content information and operation history information to the content managing server 1202 (S804).

Next, the content managing server 1202 newly adds, to the content managing unit 403, the content information obtained from the terminal apparatus B1205 as a content ID:18 (S805). Then, the content managing server 1102 notifies the terminal apparatus 1205 accordingly. Here, the terminal apparatus 1205 is notified that the transmitted content information has been newly added to the content managing unit 403 as the content ID:18 (S806).

Next, the content managing server 1202 examines whether or not an ID of the shared content item received from the terminal apparatus 1203 in S801 is present in the content managing unit 403. When the corresponding content item is present, the operation history information obtained in S804 is newly added as a replica (“16: copy”, for example) to the operation history managing unit 404 (S807). It is to be noted that, when the corresponding content item is not present, no information is added to the operation history managing unit.

Next, when the information is added to the operation history managing unit 404 in S806, the content managing server 1202 stores information to be associated with the related content item in the content managing unit 403 (S808). According to this embodiment, the child data information of the content ID:16 in the content managing unit is rewritten such that the related content ID, which is the child data, indicates “18” and the operation history ID of the operation performed to generate the child data indicates “9”. In addition, the parent data information of the content ID:18 is rewritten such that the related content ID, which is the parent data, indicates “16” and the operation history ID of the operation performed to generate the parent data indicates “9” (FIG. 24C).

As described above, performing S801 to S808 allows sharing of the content item in the terminal apparatus 1203 with the terminal apparatus 1205 and storing the reduced image in the content managing server 1202 with being associated with an original content item for management.

With this, data which can be used for restoration is stored in the content managing server 1202, and thus it is possible to restore a content item regardless of the state of other terminal apparatuses (the presence or absence of a corresponding content item, the presence or absence of network connection, and so on).

It is to be noted that, for content restoration, the processes described in Embodiment 2 (for example, the processes in S701 to 5714 illustrated in FIG. 23A and FIG. 23B, for example) are to be carried out, and thus description thereof will be omitted. In S703, however, a reduced image is selected when the content managing server selects a related data item, thereby restoring a content item from the reduced image.

In addition, according to this embodiment, the content managing server holds the reduced image even when a content item is shared between the terminal apparatuses. With this, it is possible to present a user with not only character information such as a name of a shared file and the time and date of sharing but also the reduced image, in sharing history such as transmission history, and thus there is an advantageous effect that the user also can easily understand the past history, and so on.

### Embodiment 4

In Embodiment 4, another example of a usage method for using a data management state in the content managing server according to Embodiment 1 (a characteristic data structure in which related information items of a plurality of content items are held) will be described. More specifically, the usage method for performing data migration in such a case where a user replaces a terminal apparatus will be described.

First, a configuration of a content managing server 401B according to Embodiment 4 will be described.

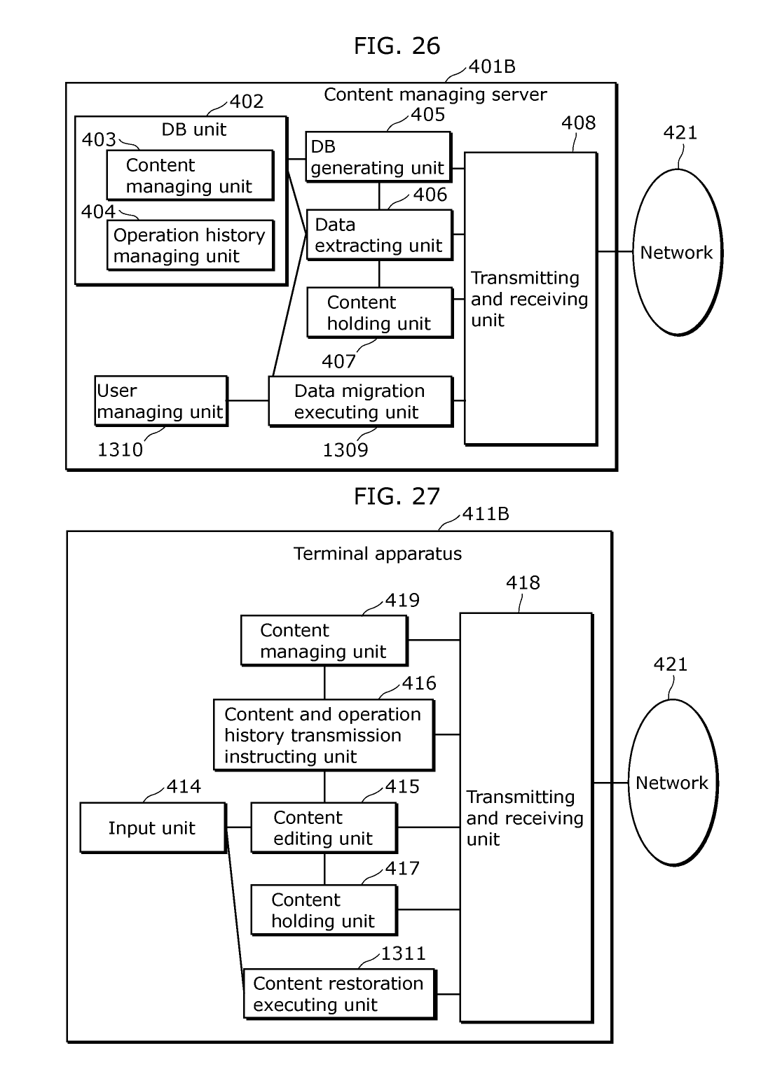

FIG. 26 is a block diagram illustrating an example of a configuration of the content managing server according to Embodiment 4. It is to be noted that elements equivalent to those in FIG. 5A share the same reference numerals and detailed explanation thereof will be omitted.

The content managing server 401B illustrated in FIG. 26 has a configuration different from the configuration of the content managing server 401 according to Embodiment 1, in that a data migration executing unit 1309 and a user managing unit 1310 are added. It is to be noted that, the configurations are each implemented using a hardware configuration such as the above-described CPU, the memory, and the communication device.

The data migration executing unit 1309, when receiving a migration request for migration of data including a content item held in a given terminal apparatus 411B (the terminal apparatus A, for example) from a terminal apparatus 411B (the terminal apparatus C, for example) different from the given terminal apparatus 411B (the terminal apparatus A, for example), executes data migration, by transmitting a content item held in the given terminal apparatus 411B (the terminal apparatus A, for example) to the different terminal apparatus 411B (the terminal apparatus C, for example), using the information held in the content managing unit 403 and the operation history managing unit 404.

To be more specific, the data migration executing unit 1309 receives a data migration requesting packet transmitted from the terminal apparatus 411B connected via the network 421. The data migration executing unit 1309 performs user authentication by comparison with the user information stored in the user managing unit 1310. Then, when the user authentication succeeds, the migration executing unit 1309, in collaboration with the data extracting unit 406, extracts the content item in the terminal apparatus owned by the user who has requested the data migration, indicated in the content information in the content managing unit 403. With this, it is possible to perform data migration of a content item in the terminal apparatus 411B of the same user to a different terminal apparatus 411B using the operation sequence equivalent to the operation sequence of the content restoration according to Embodiment 2.

Next, the configuration of the terminal apparatus 411B according to Embodiment 4 will be described.

FIG. 27 is a block diagram illustrating an example of the configuration of the terminal apparatus 411B according to Embodiment 4. It is to be noted that elements equivalent to those in FIG. 6 share the same reference numerals and detailed explanation thereof will be omitted. In addition, the configurations are each implemented using a hardware configuration such as the above-described CPU, the memory, and the communication device.

The terminal apparatus 411B illustrated in FIG. 27 has a configuration different from the configuration of the content terminal apparatus 411 according to Embodiment 1, in that a data migration requesting unit 1311 is added.

The data migration requesting unit 1311 transmits a data migration request to the network 421 via the transmitting and receiving unit 418. The data migration request from the data migration requesting unit 1311 is transmitted to the content managing server 401B through a user operation (according to the input unit 414). It is to be noted that, when issuing a data migration request, it is necessary to perform user authentication for identifying an owner of the terminal apparatus 411B. According to this embodiment, the user authentication is performed by a user with use of the input unit 414 and so on.

The following describes operations of the above-described content managing server 401B and the terminal apparatus 411B.

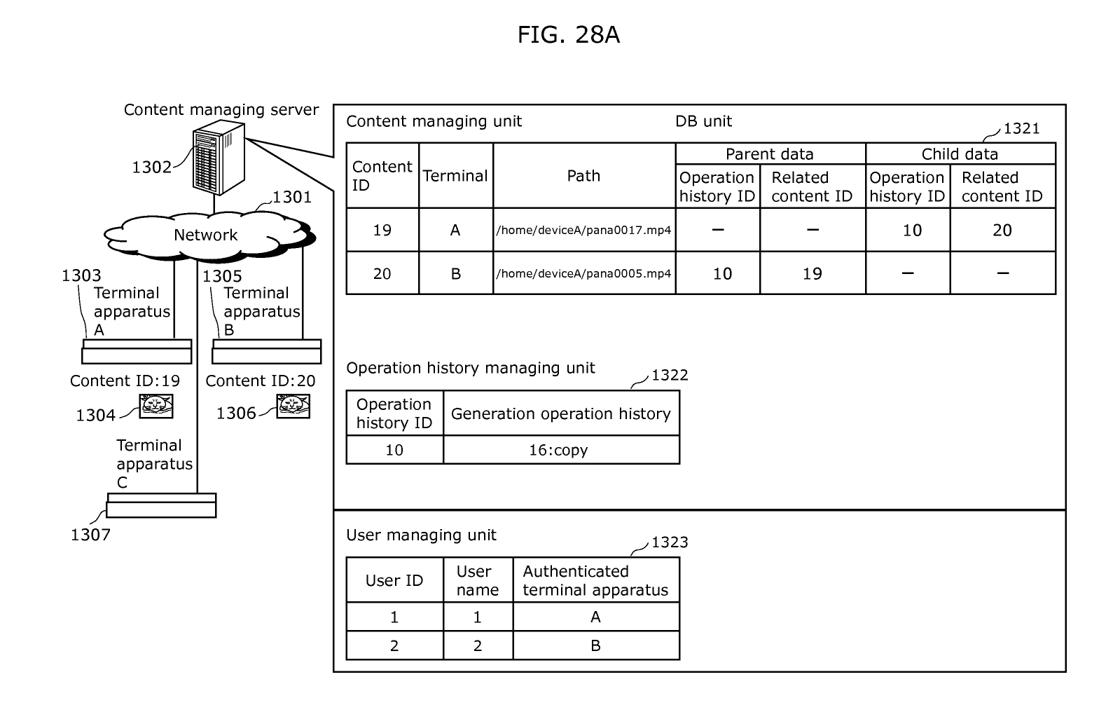

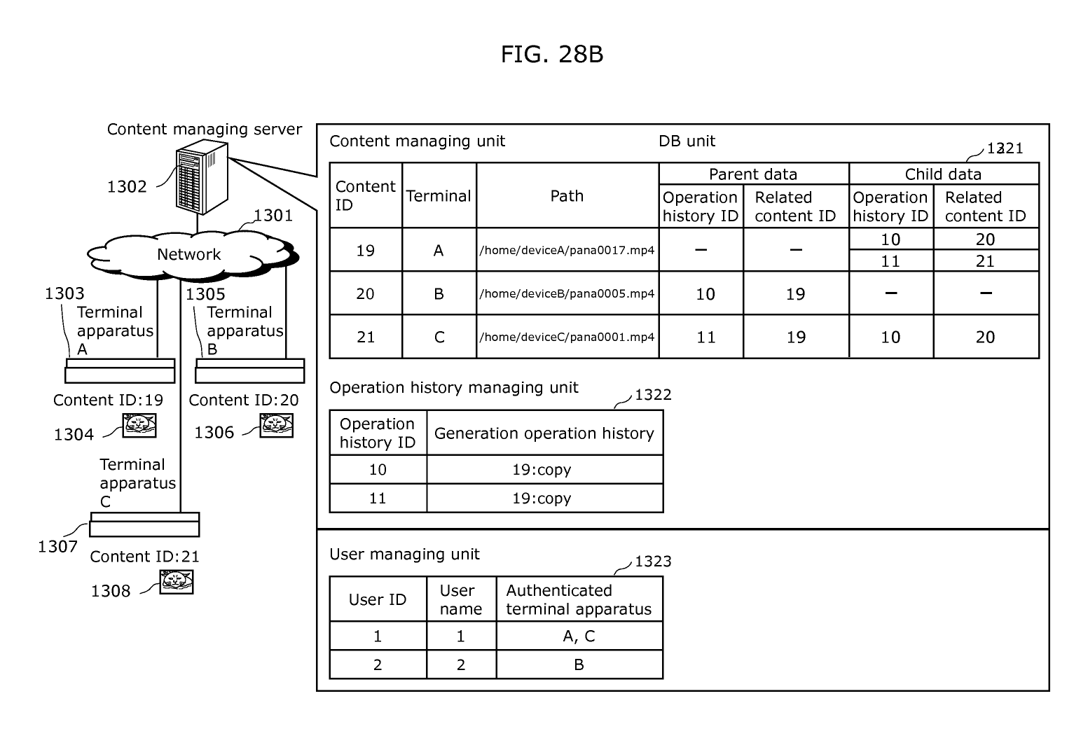

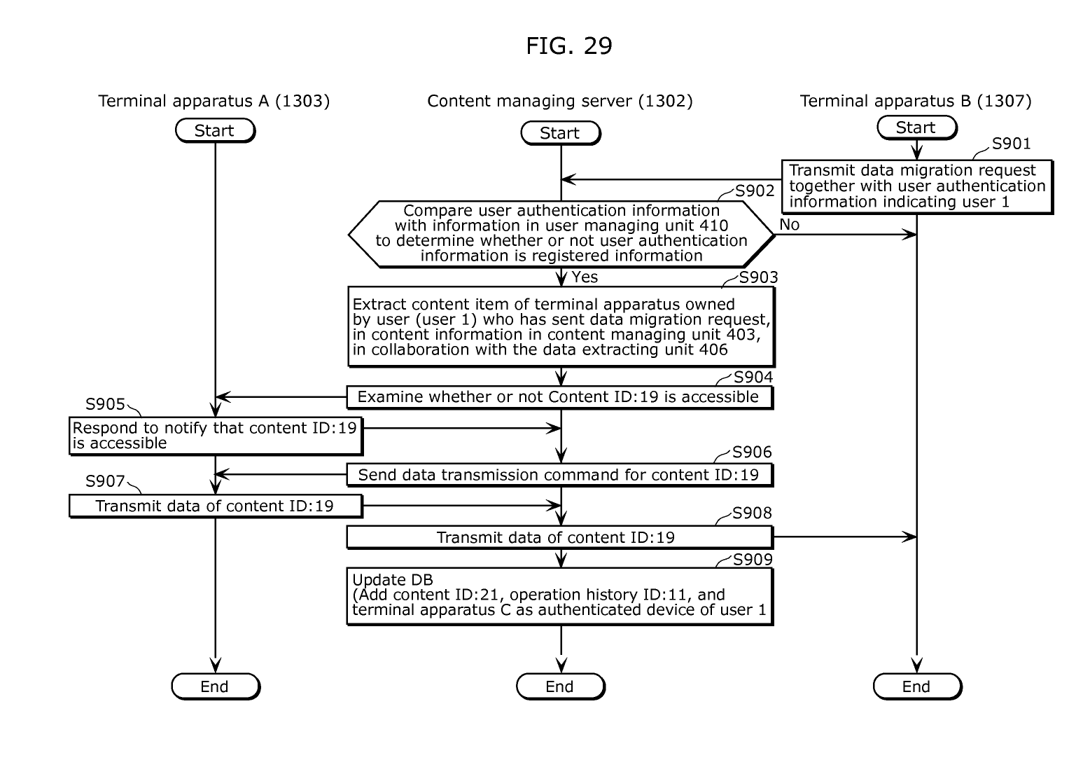

FIG. 28A and FIG. 28B are diagrams for explaining the operations according to Embodiment 4. FIG. 29 is a diagram illustrating an operation sequence according to Embodiment 4. More specifically. FIG. 28A illustrates the state prior to performing the data management processing according to this Embodiment, in which a content item 1304 in the terminal apparatus 1303 is shared with the terminal apparatus 1305. FIG. 28B illustrates the state subsequent to performing the data management processing according to this Embodiment, in which data has been migrated.

It is to be noted that a content managing server 1302 illustrated in FIG. 28A and FIG. 28B is a server which includes the configuration of the content managing server 401B, and which is an aspect of the content managing server 401B. In addition, a terminal apparatus 1303 (the terminal apparatus A), a terminal apparatus 1305 (the terminal apparatus B), and a terminal apparatus 1307 (the terminal apparatus C) illustrated in FIG. 28A and FIG. 28B are each a terminal which includes the configuration of the terminal apparatus 411B, and which is an aspect of the terminal apparatus 411B. In addition, a network 1301 is an aspect of the above-described network 421

Here, it is assumed that the terminal apparatus 1303 (the terminal apparatus A) and the terminal apparatus 1307 (the terminal apparatus C) are each a device owned by a user 1. In addition, it is assumed that the terminal apparatus 1305 (the terminal apparatus B) is a device owned by a user 2.

The following describes the operations performed when migrating a content item in the terminal apparatus 1303 (the terminal apparatus A) to the terminal apparatus 1307 (the terminal apparatus C).

First, the terminal apparatus 1307 transmits a data migration request to the content managing server 1302 according to a user operation by the user 1 (S901). At this time, the user 1 entries a user authentication information using the input unit 414 to add user information of the user 1, and transmits the data migration request.

Next, the content managing server 1302, when receiving the data migration request, compares the user authentication information received together with the data migration request with information in the user managing unit 1310 (the management information 1323), to determine whether or not the received user authentication information is registered information (S902). According to this embodiment, it is assumed that the authentication has succeeded as the user 1.

Next, when the user is authenticated (Yes in S902), the content managing server 1302, in collaboration with the data extracting unit 406, extracts a content item of the terminal apparatus owned by the user of the data migration request, in the content information in the content managing unit 403 (S903). According to this embodiment, a content ID:19 is extracted. It is to be noted that the content ID:20 is a content item of the terminal apparatus 1305, and is not extracted because a user thereof is different. In addition, when there are a plurality of corresponding content items, all of them are extracted and subsequent processes are performed.

Next, the content managing server 1302 transmits a confirmation packet to the terminal apparatus 1303 for examining whether or not the content item extracted in S903 is accessible (S904).

Next, the terminal apparatus 1303 receives the confirmation packet of the content item from the content managing server 1302. Then, when the content item is accessible, the terminal apparatus 1303 transmits a response indicating that the content item is accessible, to the content managing server 1302 (S905).

Next, the content managing server 1302, when receiving, from the terminal apparatus 1303, the response indicating that the content item is accessible, transmits a transmission command to the terminal apparatus 1303 so that the corresponding content item is transmitted to the content managing server 1302 (S906).

Next, the terminal apparatus 1303 transmits the content data of the content ID:19 to the content managing server 1302, according to the above-described transmission command (S907).

Next, the content managing server 1302 transmits the corresponding content item to the terminal apparatus 1307 (S908). Then, the terminal apparatus 1307 which has received the corresponding content item stores the received content item into the content managing unit 419 and the content holding unit 417 in the terminal apparatus 1307. As described above, the terminal apparatus 1307 can implement the data migration.

In addition, subsequent to S908, the content managing server 1302 updates the DB unit 402 to register, on the content managing unit 403 and the operation history managing unit 404, the content item generated by data migration, as a new content item. Then, the content managing server 1302 registers the terminal apparatus 1307 as an authenticated device of the user 1 on the user managing unit 1310 (management information 1323) (S909).

According to this embodiment, the content managing server 1302 registers the content item generated by data migration, as a content ID:21, on the content managing unit 403 (the content information management region 1321), and registers the content item generated by data migration, as an operation history ID:11, on the operation history managing unit 404 (the operation history management region 1322). In addition, the content managing server 1302 modifies the parent data/child data of the content ID:19 and the content ID:21 in the content managing unit 403 (the association management region) for association with the operation history information.

As described above, performing S901 to S909 allows data migration of the content items in the terminal apparatus owned by the same user, to a different terminal apparatus. In addition, the data migration described above allows not only transferring of content data but also migration of meta information related to the content item such as operation history in the content managing server. This produces an advantageous effect of greater convenience compared to the data transferring using a medium such as an optical disc.

As described above, according to the present disclosure, it is possible to implement a communication terminal capable of properly managing a relationship between a large number of content items. For example, with the content managing apparatus according to the present disclosure, it is possible to obtain, even from a secondary content generated by processing and editing a content item, the information of a base content item, and by utilizing the information, to restore a lost content item, perform migration of data to a different terminal apparatus while maintaining the relativity between other content items, and so on.

It is to be noted that, in each of the embodiments describe above, each of the constituent elements may be configured by dedicated hardware, or may be implemented by executing a software program suitable to each of the constituent elements. Each of the constituent elements may be realized by means of a program executing unit, such as a CPU and a processor, reading and executing the software program recorded on a recording medium such as a hard disk or a semiconductor memory. Here, the software which realizes an image decoding apparatus and the like according to each of the embodiments described above is a program as described below.

More specifically the program is a program for a content managing apparatus which is connected to a first communication apparatus and a second communication apparatus and manages a content item held by the first communication apparatus and the second communication apparatus, the program causing a computer to execute: storing information items including (i) first content information for identifying a first content item, (ii) second content information for identifying a second content item used in an editing operation performed on the first content item, (iii) information indicating a parent-child relationship between the first content item and the second content item, and (iv) information for associating the first operation history information with the first content information and the second content information, the first operation history information indicating history of the editing operation performed on the first content item; and when a request is received from the first communication apparatus, transmitting at least one of the first content item and the second content item to one of the first communication apparatus and the second communication apparatus, using the information items managed in the storing.

Furthermore, in each of the above-described embodiments, these general and specific aspects may be implemented using a method. More specifically, the content managing method according to an aspect of the present invention may be a content managing method performed by a content managing apparatus which is connected to a first communication apparatus and a second communication apparatus and manages a content item held by the first communication apparatus and the second communication apparatus, the content managing method including: managing information items including (i) first content information for identifying a first content item, (ii) second content information for identifying a second content item used in an editing operation performed on the first content item, (iii) information indicating a parent-child relationship between the first content item and the second content item, and (iv) information for associating the first operation history information with the first content information and the second content information, the first operation history information indicating history of the editing operation performed on the first content item; and when a transmission request for the first content item is received from the first communication apparatus, transmitting at least one of the first content item and the second content item to one of the first communication apparatus and the second communication apparatus, using the information items managed in the managing. Here, since transmission in the transmitting step enables data restoration or data migration, the transmission is assumed to be a concept including restoration and migration.

Here, in the content managing method, the transmission request may be a restoration request for restoring the first content item which the first communication apparatus has lost, and in the transmitting, when the restoration request is received from the first communication apparatus, (i) the first content item held by the second communication apparatus or the content managing apparatus, or (ii) a content item generated by the editing operation performed on the first content item may be transmitted to the first communication apparatus, as restoration processing for the first content item. In addition, the transmission request may be a migration request demanding migration of data including the content item held by the first communication apparatus, to the second communication apparatus, and in the transmitting, when the migration request is received from the first communication apparatus, the data held by the first communication apparatus may be transmitted to the second communication apparatus, as processing of the migration. The content managing apparatus, the content managing method, and the like according to one or more aspects of the present invention have been described above based on the embodiments; however, the present invention is not limited to these embodiments. Other forms in which various modifications apparent to those skilled in the art are applied to the embodiment, or forms structured by combining elements of different embodiments may be included within the scope of the one or more aspects of the present invention, unless such changes and modifications depart from the scope of the present invention.

### INDUSTRIAL APPLICABILITY

With the content managing apparatus and the terminal apparatuses (communication terminals) according to the present invention, it is possible to obtain information of a base content item, even with a new content item generated by combining a plurality of content items, trimming part of a content item, and so on. Furthermore, it is possible to restore a lost content item, perform migration of data to a different terminal apparatus while maintaining the relativity between other content items, and so on.

### REFERENCE SIGNS LIST

100 decentral content management system
101, 401, 401A, 401B, 602, 702, 802, 902, 1002, 1102, 1202, 1302 content managing server
102 user managing unit
103, 403, 419 content managing unit
104, 415 content editing unit
105, 115, 408, 418 transmitting and receiving unit
111, 411, 411A, 411B, 603, 703, 803, 903, 905, 1003, 1005, 1103, 1105, 1203, 1205, 1303, 1305, 1307 terminal apparatus
112, 414 input unit
113 content display unit
114, 407, 417, content holding unit
121, 421, 601, 701, 801, 901, 1001, 1101, 1201, 1301 network
151 DB
400 content management system
402 DB unit
404 operation history managing unit
405 DB generating unit
406 data extracting unit
416 content and operation history transmission instructing unit
501 user IF device
502 CPU
503 memory
504 communication device
   604, 605, 704, 705, 706, 804, 805, 904, 906, 1004, 1006, 1104, 1106, 1107, 1204, 1206, 1207, 1304, 1306, 1308 content item
621, 721, 821, 921, 1021, 1121, 1221, 1321 content information management region
622, 722, 822, 922, 1022, 1122, 1222, 1322 operation history management region
1323 management information
1108 checking unit
1109 executing unit
1117 content restoration executing unit
1110 content restoration requesting unit
1309 data migration executing unit
1310 user managing unit
1311 data migration requesting unit
4051 content information editing unit
4052 operation history information editing unit
4053 associating unit

1. A content managing apparatus for managing a content item using a storage unit including a content information management region and an operation history management region, the content managing apparatus comprising:
a content information editing unit configured to newly add first content information for identifying a first content item to the content information management region;
an operation history information editing unit configured to add, to the operation history management region, first operation history information indicating history of an editing operation performed on the first content item, when second content information for identifying a second content item is stored in the storage unit, the second content item being used in the editing operation performed on the first content item and being different from the first content item; and
an associating unit configured to store (i) information indicating a parent-child relationship between the first content item and the second content item and (ii) information for associating the first operation history information with the first content information and the second content information, into an association management region included in each of the first content information and the second content information in the content information management region, when the first operation history information is added by the operation history information editing unit.

2. The content managing apparatus according to claim 1,
wherein, when receiving at least (i) first information for identifying the first content item and (ii) second information indicating the history of the editing operation performed on the first content item from a first communication apparatus connected to the content managing apparatus, the content information editing unit is configured to newly add the first content information to the content information management region according to the first information received from the first communication apparatus.

3. The content managing apparatus according to claim 2,
wherein the operation history information editing unit is configured to: search the storage unit for the second content information according to the first information and the second information; and, when the second content information is present, newly add the first operation history information to the operation history management region according to the second information.

4. The content managing apparatus according to claim 2,
wherein the content information editing unit is configured to newly add, according to the first information, at least (i) an identifier indicating the first content item and (ii) an identifier indicating the first communication apparatus holding the first content item, as the first content information, to the content information management region.

5. The content managing apparatus according to claim 2,
wherein the operation history information editing unit is configured to newly add, according to the second information, at least (i) an identifier indicating the editing operation and (ii) information for associating the editing operation with the second content information, as the first operation history information, to the operation history management region.

6. The content managing apparatus according to claim 2,
further comprising a content holding unit configured to hold a content item,
wherein the content holding unit is configured to hold the first content item when receiving the first content item from the first communication apparatus.

7. The content managing apparatus according to claim 1,
wherein the editing operation includes an operation for generating the first content item by replicating the second content item.

8. The content managing apparatus according to claim 1,
wherein the editing operation includes an operation for generating the first content item by trimming the second content item.

9. The content managing apparatus according to claim 1,
wherein the second content item includes a plurality of content items different from each other,
the editing operation includes an operation for generating the first content item by editing the plurality of content items, and
the associating unit is configured to store (i) information indicating a parent-child relationship between the first content item and each of the plurality of content items and (ii) information for associating the first operation history information with the first content information and each of the plurality of content items, into the association management region which is provided in the content information management region and is included in each of the first content information and information of each of the plurality of content items for identifying a corresponding one of the content items.

10. The content managing apparatus according to claim 2,
wherein the editing operation includes an operation for generating the first content item by receiving, by the first communication apparatus, a replica of the second content item held by a second communication apparatus connected to the content managing apparatus, and
the content information management region holds, as the second content information, (i) an identifier indicating the second content item and (ii) an identifier indicating the second communication apparatus holding the second content item.

11. The content managing apparatus according to claim 1,
wherein, when receiving deletion history information from the first communication apparatus, the content information editing unit is further configured to delete the first content information from the content information management region in the storage unit, the deletion history information indicating history of an editing operation of deleting the first content item,
the operation history information editing unit is further configured to delete the first operation history information from the operation history management region when the first operation history information is stored in the operation history management region, and
the associating unit is further configured to delete (i) information associated with the first content information and (ii) information associated with the first operation history information, from the association management region which is provided in the content information management region and is included in the first content information and the second content information.

12. The content managing apparatus according to claim 2, further comprising
a restoration executing unit configured to execute restoration of the first content item using information held in the content information management region and the operation history management region when a restoration request for the first content item which the first communication apparatus has lost is received from the first communication apparatus.

13. The content managing apparatus according to claim 12,
wherein the restoration executing unit includes: a checking unit configured to perform checking by searching the content information management region and the operation history management region which include the association management region in which the second content information identified based on the first content information and the second operation history information including the second content information are present; and
an executing unit configured, when the checking unit has confirmed that the second content information and the second operation history information are present, to restore the first content item of the first communication apparatus, by causing a second communication apparatus to transmit the second content item based on the second operation history information, the second communication apparatus being indicated by the second content information and connected to the content managing apparatus.

14. The content managing apparatus according to claim 12,
wherein the content managing apparatus further generates and holds a thumbnail of the first content item, and
the restoration executing unit is configured to execute restoration of the first content item using the thumbnail, when receiving a restoration request for the first content item which the first communication apparatus has lost is received from the first communication apparatus.

15. The content managing apparatus according to claim 2, further comprising
a data migration executing unit configured to execute data migration by transmitting a content item held by the first communication apparatus to a second communication apparatus connected to the content managing apparatus, using information held in the content information management region and the operation history management region, when receiving, from the second communication apparatus, a migration request for migration of data including a content item held by the first communication apparatus.

16. A content managing method performed by a content managing apparatus which is connected to a first communication apparatus and a second communication apparatus and manages a content item held by the first communication apparatus and the second communication apparatus, the content managing method comprising:
managing information items including (i) first content information for identifying a first content item, (ii) second content information for identifying a second content item which is used in an editing operation performed on the first content item and different from the first content item, (iii) information indicating a parent-child relationship between the first content item and the second content item, and (iv) information for associating the first operation history information with the first content information and the second content information, the first operation history information indicating history of the editing operation performed on the first content item; and
when a transmission request for the first content item is received from the first communication apparatus, transmitting at least one of the first content item and the second content item to one of the first communication apparatus and the second communication apparatus, using the information items managed in the managing.

17. The content managing method according to claim 16,
wherein the transmission request is a restoration request for restoring the first content item which the first communication apparatus has lost, and
in the transmitting, when the restoration request is received from the first communication apparatus, (i) the first content item held by the second communication apparatus or the content managing apparatus, or (ii) a content item generated by the editing operation performed on the first content item is transmitted to the first communication apparatus, as restoration processing for the first content item.

18. The content managing method according to claim 16,
wherein the transmission request is a migration request demanding migration of data including the content item held by the first communication apparatus, to the second communication apparatus, and
in the transmitting, when the migration request is received from the first communication apparatus, the data held by the first communication apparatus is transmitted to the second communication apparatus, as processing of the migration.

19. A non-transitory computer-readable recording medium on which a program is recorded, the program: being for a content managing apparatus which is connected to a first communication apparatus and a second communication apparatus and manages a content item held by the first communication apparatus and the second communication apparatus; and causing a computer to execute:
storing information items including (i) first content information for identifying a first content item, (ii) second content information for identifying a second content item which is used in an editing operation performed on the first content item and is different from the first content item, (iii) information indicating a parent-child relationship between the first content item and the second content item, and (iv) information for associating the first operation history information with the first content information and the second content information, the first operation history information indicating history of the editing operation performed on the first content item; and
when a transmission request is received from the first communication apparatus, transmitting at least one of the first content item and the second content item to one of the first communication apparatus and the second communication apparatus, using the information items managed in the storing.
